(19) United States
(12) Patent Application Publication
(10) Pub. No.: US 2025/0132890 A1
(43) Pub. Date: Apr. 24, 2025

(54) APPARATUSES AND METHODS FOR PROTECTING A REFERENCE SIGNAL AND ADJUSTING TIMING ADVANCE (TA) VALUES IN FULL-DUPLEX TRANSMISSION

(71) Applicant: Huawei Technologies Co., Ltd., Shenzhen (CN)

(72) Inventors: Liqing Zhang, Ottawa (CA); Jianglei Ma, Ottawa (CA); Hao Tang, Ottawa (CA)

(21) Appl. No.: 18/990,243

(22) Filed: Dec. 20, 2024

Related U.S. Application Data
(63) Continuation of application No. PCT/CN2022/100230, filed on Jun. 21, 2022.

(51) Int. Cl. H04L 5/14; H04L 5/00

(52) U.S. Cl. CPC H04L 5/14; H04L 5/0048

(57) ABSTRACT

Aspects of the present disclosure provide methods and apparatuses for protecting a reference signal (RS) and/or adjusting timing advance (TA) values to be used for timing synchronization between an apparatus (e.g. user equipment (UE))) and a device (e.g. transmit-and-receive point (TRP)) in a wireless network. The device operates in full-duplex (FD) mode and the apparatus operates in half-duplex (HD) or FD mode. In some embodiments, RSs transmitted in uplink and downlink directions are protected by puncturing one or more portions of time-frequency resources so that interference from other signals can be avoided or mitigated. The punctured portion of the time-frequency resources may be one or more symbols that together overlaps with a symbol at which the RS is to be received or sent. The device may send information indicating the portion to puncture using a higher-layer signaling, a dynamic signaling, or a preconfiguration by the network.

### CROSS-REFERENCE TO RELATED APPLICATIONS

The present application is a continuation of International Application No. PCT/CN2022/100230, filed on Jun. 21, 2022, the disclosure of which is hereby incorporated by reference in its entirety.

### TECHNICAL FIELD

The present application relates to wireless communication, and more specifically to reference signal transmission and timing advance (TA) in the context of full-duplex transmission.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a TRP may wirelessly transmit information to a UE in a downlink communication over a particular frequency (or range of frequencies) for a particular duration of time. The frequency and time duration are examples of resources, typically referred to as time-frequency resources. Multiple access occurs when more than one UE is scheduled on a set of time-frequency resources. Each UE uses a portion of the time-frequency resources to receive data from the TRP in the case of a downlink communication, or to transmit data to the TRP in the case of an uplink communication.

A time domain signal transmission structure may be defined for performing the wireless communication, e.g. to allow for timing reference and timing alignment of basic time domain transmission units. For example, a slot may be defined having a particular duration of time in which a particular number of symbols (e.g. orthogonal frequency division multiplexing (OFDM) symbols) may be transmitted.

Time division duplex (TDD) and frequency division duplex (FDD) are two resource multiplexing technologies that have been widely used in current wireless networks. In order to enhance spectrum efficiency for FDD, reduce the transmission latency and/or improve uplink (UL) coverage, full-duplex (FD) transmission mode is often desired to be used. In FD transmission mode, both transmissions and receptions may share a frequency band or a sub-band (i.e., a portion of the channel bandwidth) in the frequency band. As a result, in FD transmission mode, transmitting and receiving can be performed simultaneously over shared spectrum in a node, thereby possibly enhancing spectrum efficiency, reducing transmission latency and/or improving UL coverage.

### SUMMARY

For a node (e.g. apparatus or device in a wireless network) that supports full duplex (FD) transmissions, a transmission signal may be a self-interference signal to a reception signal, e.g. due to signal leakage (such as over a leakage channel) at the transmission side of the node within the shared spectrum for both transmission and reception. Thus, signal processing techniques, such as self-interference cancellation (SIC), may be applied to overall received signals at the node so that the actual reception signal (reception signal not affected by the self-interference) may be more effectively detected and appropriately decoded for example using SIC. To estimate the self-interference, it is often desirable to keep reference signals (RSs), which are employed in the transmission signal at the transmission side of the node, uncontaminated by an incoming reception signal from other nodes so that the leakage channel may be more accurately estimated using the reference signals. In some embodiments, the present disclosure addresses how to protect RSs from the interference by incoming reception signals when one or both nodes participating in the transmission (e.g. base station (BS), user equipment (UE)) operate in FD mode.

In a wireless network, for example in a current time division duplex (TDD) network, downlink (DL) RS signals, such as demodulation reference signal (DMRS), from a BS may be utilized for channel estimation at a UE side. In such circumstances, interference to the DL RS signal may be no significant concern at the transmission side or the BS side. The current timing alignment for DL and uplink (UL) transmissions at the BS side may be based on timing advance (TA) signalling for UE UL transmissions, and the current TA granularity is 0.52 μs and may be indicated by a medium access control (MAC) control element (CE) or radio resource control (RRC) signaling. However, such a TA adjustment scheme may not be able to meet requirements for FD transmissions in future wireless networks in terms of TA granularity due to, for example, slow timing adjustment indication (e.g. MAC CE indication, RRC signaling) for symbol alignments. It may be noted that, in FD transmission, an apparatus (e.g. UE) or a device (e.g. BS, TRP) can transmit and receive data at the same time. In the present disclosure, ‘FD transmission’, ‘FD mode’, ‘FD operation’, ‘FD operation mode’ and other similar terms may be interchangeably used and have substantially the same meaning. The slow timing adjustment indication may not be desirable especially for network transmissions using symbols with durations of for example 1 us or even shorter, such as new radio (NR) orthogonal frequency division multiplexing (OFDM) symbol with subcarrier spacing (SCS) of 960 kHz. In some embodiments, the present disclosure addresses how to make faster and finer timing alignment of both transmission and reception signals, e.g. when both nodes participating in the transmission (e.g. both base station (BS) and user equipment (UE)) operate in FD mode.

As noted above, the present disclosure provides apparatuses and methods for protecting a reference signal and/or adjusting timing advance (TA) values to be used for timing synchronization in full duplex (FD) transmission, thereby possibly enhancing FD transmissions in wireless networks.

According to an aspect of the present disclosure, there is provided a method performed by an apparatus, for example but not limited to a user equipment (UE). The method may include receiving, from a device operating in full-duplex (FD) mode, information indicating to the apparatus a first portion of time-frequency resources, where the first portion of the time-frequency resources is to be punctured for a transmission of the apparatus. The method may further include sending, to the device, the transmission on a second portion of the time-frequency resources, where the second portion of the time-frequency resources excludes the first portion of the time-frequency resources.

In some embodiments, the method may further include receiving, from the device, an indication to send a reference signal (RS) in the transmission on a symbol included in the time-frequency resources, and sending, to the device, the RS on the symbol. In some embodiments, the time-frequency resources may include one or more symbols in a receiving direction that together overlap with the symbol at which the RS is transmitted by the apparatus. In some embodiments, the one or more symbols in the receiving direction may include a third portion that is at the same frequency location as the RS and is punctured.

In some embodiments, where a RS from the device is sent, the time-frequency resources may include one or more symbols in a transmitting direction that together overlap with a symbol at which the RS from the device is sent. In some embodiments, the one or more symbols in the transmitting direction may include the first portion of the time-frequency resources.

In some embodiments, the time-frequency resources may be configured by one or a combination of the information indicating to the apparatus the first portion of the time-frequency resources or another signaling. The information indicating to the apparatus the first portion of the time-frequency resources or the other signaling may be included in at least one of: a higher-layer signaling, a dynamic signaling, or a preconfiguration by the network. In some embodiments, the information indicating to the apparatus the first portion of the time-frequency resources may be included in a downlink control information (DCI) or in a sidelink control information (SCI).

In some embodiments, the method may further include receiving, from the device, a dynamic signaling including an indication of timing advance adjustment to be applied to a transmission sent by the apparatus to the device.

In some embodiments, the method may further include receiving, from the device in higher layer signaling, an indication of a first timing advance adjustment to be applied to a transmission sent by the apparatus to the device. The method may further include receiving, from the device in DCI, an indication of a second timing advance adjustment to be applied instead of or in addition to the first timing advance adjustment.

According to an aspect of the disclosure there is provided an apparatus including a memory and a processor. The memory is configured to store processor-executable instructions and the processor is configured to execute the processor-executable instructions to cause the apparatus to perform a method consistent with the embodiment described above.

According to another aspect of the present disclosure, there is provided a method performed by a device operating in full-duplex (FD) mode, for example but not limited to a base station (BS) that operates in FD mode. The method may include transmitting, to an apparatus, information indicating to the apparatus a first portion of time-frequency resources, wherein the first portion of the time-frequency resources is to be punctured by the apparatus for a transmission of the apparatus. The method may further include receiving the transmission of the apparatus on a second portion of the time-frequency resources, the second portion of the time-frequency resources excluding the first portion of the time-frequency resources.

In some embodiments, the method may further include transmitting a reference signal (RS) on the first portion of the time-frequency resources.

In some embodiments, the method may further include transmitting, to the apparatus, an indication to transmit a RS on a symbol included in the time-frequency resources. The method may further include receiving, from the apparatus, the RS on the symbol, and puncturing, in a transmitting direction, a time-frequency location at which the RS is received. In some embodiments, the time-frequency resources may include one or more symbols in the transmitting direction that together overlap with the symbol at which the RS is transmitted by the apparatus. In some embodiments, the one or more symbols in the transmitting direction may include a third portion that is at the same frequency location as the RS and is punctured by the device.

In some embodiments, a RS from the device is being sent, and the time-frequency resources may include one or more symbols in a receiving direction that together overlap with a symbol at which the RS from the device is sent. In some embodiments, the one or more symbols in the receiving direction may include the first portion of the time-frequency resources.

In some embodiments, the time-frequency resources may be configured by one or a combination of the information indicating to the apparatus the first portion of the time-frequency resources or another signaling. The information indicating to the apparatus the first portion of the time-frequency resources or the other signaling may be included in at least one of: a higher-layer signaling, a dynamic signaling, or a preconfiguration by the network. In some embodiments, the information indicating to the apparatus the first portion of the time-frequency resources may be included in a downlink control information (DCI) or in a sidelink control information (SCI).

In some embodiments, the method may further include transmitting, to the apparatus, a dynamic signaling including an indication of timing advance adjustment to be applied to a transmission sent by the apparatus to the device.

In some embodiments, the method may further include transmitting, to the apparatus in higher layer signaling, an indication of a first timing advance adjustment to be applied to a transmission sent by the apparatus to the device. The method may further include transmitting, to the apparatus in DCI, an indication of a second timing advance adjustment to be applied instead of or in addition to the first timing advance adjustment.

According to an aspect of the disclosure there is provided a device including a memory and a processor. The memory is configured to store processor-executable instructions and the processor is configured to execute the processor-executable instructions to cause the device to perform a method consistent with the embodiment described above.

The following technical benefit may be achieved in some embodiments: FD transmission in a wireless network may be enhanced by puncturing a first portion and/or a second portion of time-frequency resources for transmissions which may include one or more reference signals. Interference to the reference signals from other signals may be avoided or mitigated by puncturing the first and/or second portion of time-frequency resources.

The following technical benefit may be achieved in some embodiments: FD transmission in a wireless network may be enhanced as RSs transmitted in the UL and DL directions may be protected, especially when both an apparatus (e.g. UE) and a device (e.g. BS) in the network are both operating in FD mode. The RSs transmitted in the UL and DL directions may be protected by puncturing portion(s) of the time-frequency resources such that one or more symbols in the punctured portion(s) together overlap with a symbol at which the RS is to be received or sent.

The following technical benefit may be achieved in some embodiments: FD transmission in a wireless network may be enhanced through faster and finer timing alignment of both transmission and reception signals. The faster and finer timing alignment may be achieved by sending at least some timing advance adjustment information in dynamic signaling, such as in DCI.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates user equipments (UEs) communicating with a TRP, according to one embodiment;

FIG. 6 illustrates an example network with two nodes supporting full-duplex (FD) operation mode where reference signals are employed for channel estimation;

FIG. 7 illustrates an example timing advance (TA) applied based on the round trip time (RTT) between a TRP and a UE in a division duplex (TDD) network, where the TRP and the UE are operating in half-duplex (HD) TDD mode;

FIG. 8 and FIG. 9 illustrate methods for protecting a reference signal and adjusting TA in a network where a TRP is operating in FD mode and a UE is operating in HD mode, according to embodiments of the present disclosure;

FIG. 10 and FIG. 11 illustrate timing alignments for a TRP and a UE in a network where both the TRP and the UE are operating in FD mode, according to embodiments of the present disclosure;

FIG. 12 and FIG. 13 illustrate methods for protecting a reference signal and adjusting TA in a network where both a TRP and a UE are operating in FD mode, according to embodiments of the present disclosure;

FIG. 14 and FIG. 15 illustrate DL and UL transmissions with orthogonal RSs over symbol and/or slot alignment, according to embodiments of the present disclosure; and

FIG. 16 and FIG. 17 illustrate methods performed by an apparatus and a device, according to embodiments of the present disclosure.

### DETAILED DESCRIPTION OF ILLUSTRATIVE EMBODIMENTS

For illustrative purposes, specific example embodiments will now be explained in greater detail below in conjunction with the figures.

### Example Communication Systems and Devices

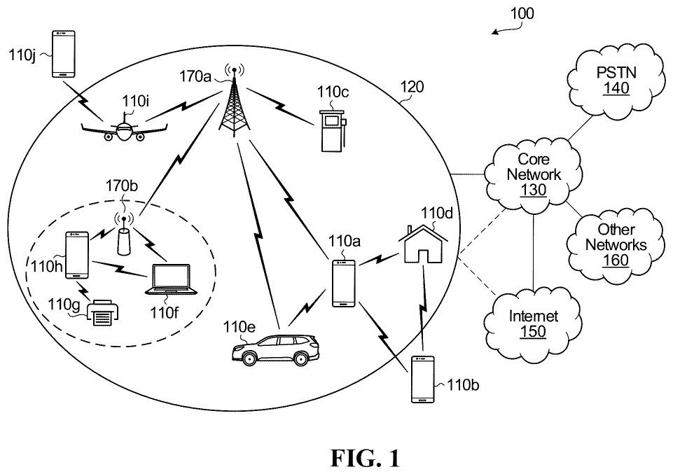

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

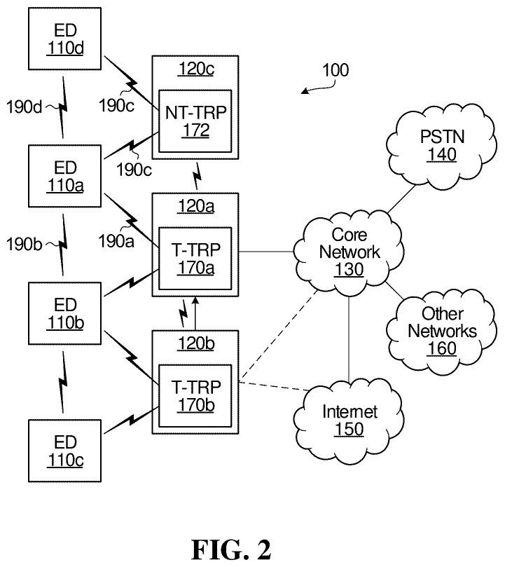

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

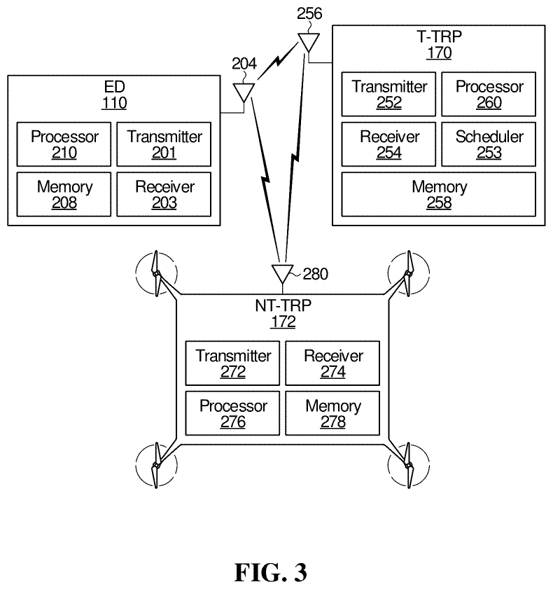

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, baseband unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

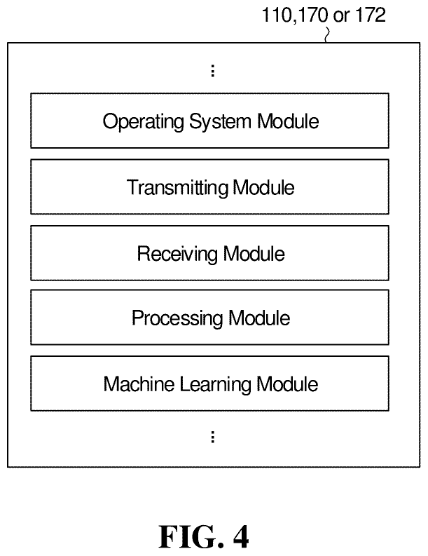

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC control element (CE)). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

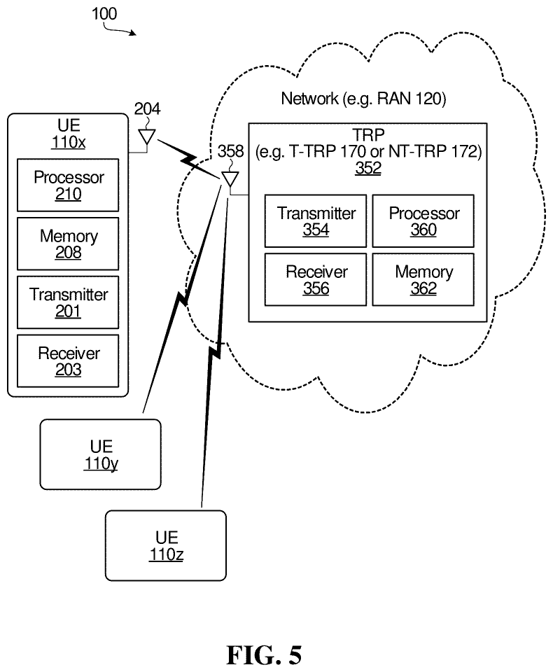

FIG. 5 illustrates three EDs communicating with a TRP 352 in the communication system 100, according to one embodiment. The three EDs are each illustrated as a respective different UE, and will be referred to as UEs 110x, 110y, and 110z. In the following, the reference character 110 will be used when referring to any one of the UEs 110x, 110y, 110z, or any other UE (e.g. the UEs 110a-j introduced earlier).

UE 110 represents any suitable end user device for wireless operation and may include devices such as (but not limited to) a smartphone, a laptop, a computer, a tablet, a wireless sensor, a consumer electronics device, a smart book, a vehicle, a car, a truck, a bus, a train, an IoT device, an industrial device, a cellular telephone, a station (STA), a machine type communication (MTC) device, a personal digital assistant (PDA), a wireless transmit/receive unit (WTRU), a mobile station, a fixed or mobile subscriber unit, or an apparatus (e.g. communication module, modem, or chip) in any of the forgoing devices.

The TRP 352 may be T-TRP 170 or NT-TRP 172. In some embodiments, the parts of the TRP 352 may be distributed. For example, some of the modules of the TRP 352 may be located remote from the equipment housing the antennas of the TRP 352, and may be coupled to the equipment housing the antennas over a communication link (not shown). For example, a baseband unit (BBU) of the TRP 352 may be remote from the radio frequency unit (RFU) of the TRP 352. As another example, the antenna(s) of the TRP 352 may be remote from the RFU of the TRP 352, or alternatively the antenna(s) may be integrated into the RFU. The term antenna, as used herein, also encompasses a panel, e.g. a panel antenna.

Because the TRP 352 may be distributed, in some embodiments the term TRP 352 may also or instead refer to modules on the network side that perform processing operations, such as resource allocation (scheduling), message generation, encoding/decoding, etc., and that are not necessarily part of the equipment housing the antennas of the TRP 352. The modules may also be coupled to other TRPs. In some embodiments, the TRP 352 may actually be a plurality of TRPs that are operating together to serve the UEs, e.g. through coordinated multipoint transmissions.

The TRP 352 includes a transmitter 354 and receiver 356, which may be integrated as a transceiver. The transmitter 354 and receiver 356 are coupled to one or more antennas 358. Only one antenna 358 is illustrated. The TRP 352 further includes a processor 360. The processor 360 performs (or controls the TRP 352 to perform) the operations described herein as being performed by the TRP 352, as illustrated below and elsewhere in the present disclosure. The processor 360 generates messages for downlink transmission and processes received uplink transmissions. Generation of messages for downlink transmission may include arranging the information in a message format, encoding the message, modulating, performing beamforming (as necessary), etc. Processing uplink transmissions may include performing beamforming (as necessary), demodulating and decoding the received messages, etc. Although not illustrated, the processor 360 may form part of the transmitter 354 and/or receiver 356. The TRP 352 further includes a memory 362 for storing information (e.g. control information and/or data). The information stored in the memory 362 may include control information and/or data associated with some or all of the operations performed by the TRP 352, for example some or all instructions to be executed by the processor 360 of the TRP 352.

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

Each UE 110 (e.g. each of UEs 110x, 110y, and 110z) includes a respective processor 210, memory 208, transmitter 201, receiver 203, and one or more antennas 204, as described earlier. Only the processor 210, memory 208, transmitter 201, receiver 203, and antenna 204 for UE 110x is illustrated for simplicity, but the other UEs 110y and 110z also include the same respective components.

The processor 210 performs (or controls the UE 110 to perform) the operations described herein as being performed by the UE 110, as illustrated below and elsewhere in the present disclosure. The processor 210 generates messages for uplink transmission and processes received downlink transmissions. Generation of messages for uplink transmission may include arranging the information in a message format, encoding the message, modulating, performing beamforming (as necessary), etc. Processing received downlink transmissions may include performing beamforming (as necessary), demodulating and decoding the received messages, etc. Although not illustrated, the processor 210 may form part of the transmitter 201 and/or receiver 203. Although not illustrated, the memory 208 may form part of the processor 210. The memory 208 may be configured to store control information and/or data associated with some or all of the operations performed by the UE 110, for example some or all instructions to be executed by the processor 210 of the UE 110.

### Wireless Communication Between the UEs and TRP

Wireless communication between UEs (e.g. UEs 110x, 110y, and 110z) and the TRP 352 are performed over a spectrum of frequencies occupying a bandwidth. The spectrum may comprise one or more carriers and/or one or more bandwidth parts (BWPs). The spectrum will be referred to as frequency resources. The wireless communication occurs over a duration of time, which will be referred to as time resources. Therefore, the term time-frequency resources will be used to refer to the time resources and frequency resources over which the wireless communication occurs. Bits to be wirelessly communicated are mapped to symbols for wireless transmission over the time-frequency resources. A symbol may be transmitted on a single-carrier waveform or a multi-carrier waveform. In the case of a multi-carrier waveform, the symbol may be referred to as a multi-carrier symbol.

An example of a multi-carrier symbol is an orthogonal frequency-division multiplexing (OFDM) symbol. A multi-carrier symbol may be generated as follows. Serial-to-parallel conversion is performed on the set of bits to be transmitted to result in M parallel groups of bits. Each group of bits is then mapped to a respective data symbol (e.g. using a modulator) to result in M data symbols X₁ to X_{M}. Each data symbol X₁ to X_{M} is for transmission on a respective different subcarrier, and the subcarriers have a particular subcarrier spacing. The data symbols X₁ to X_{M} undergo the inverse discrete fourier transform (IDFT) (which may be implemented as an inverse fast fourier transform (IFFT) in some embodiments) to result in N time-domain sample outputs, where N is typically greater than M, followed by parallel-to-serial conversion and optional cyclic prefix (CP) insertion. A multi-carrier symbol is thereby generated that includes an optional redundancy portion (e.g. a CP) and an information portion that carries the data and/or control information represented by the bits. The multi-carrier symbol may be transmitted over time-frequency resources consisting of a particular number of subcarriers in the frequency domain and a particular duration of time in the time domain. The duration of time over which a symbol is transmitted may be referred to as the symbol duration.

A resource element (RE) may refer to 1 subcarrier by 1 symbol in the time-frequency resources. A resource block (RB) (sometimes called a physical resource block (PRB)) may refer to a unit of time-frequency resources that can be allocated/scheduled for transmission.

Different portions of the time-frequency resources may be partitioned into different channels dedicated to different purposes. For example, one portion of the time-frequency resources may be an uplink control channel in which the UEs 110x, 110y, and 110z may transmit uplink control information (UCI). The uplink control channel may be called a physical uplink control channel (PUCCH). As another example, another portion of the time-frequency resources may be a downlink control channel in which the TRP 352 may transmit downlink control information (DCI). The downlink control channel may be called a physical downlink control channel (PDCCH). As another example, another portion of the time-frequency resources may be a physical downlink shared channel (PDSCH) used to transmit data from the TRP 352 to one or more UEs. As another example, another portion of the time-frequency resources may be a physical uplink shared channel (PUSCH) used to transmit data from one or more UEs to TRP 352. The foregoing are only examples. Additional and/or different channels may be defined.

Depending upon the application, some or all of the uplink transmissions from the UEs may be granted by the network. For example, a UE requests uplink time-frequency resources from the TRP 352, the TRP 352 grants the uplink time-frequency resources, and then the UE sends the uplink transmission using the granted uplink time-frequency resources. Additionally or alternatively, some or all of the uplink transmissions from the UEs may be grant-free. That is, a UE may send an uplink transmission using certain uplink time-frequency resources possibly shared with other UEs, without specifically requesting use of those time-frequency resources. A grant-free uplink transmission does not need a dynamic and explicit scheduling grant from the TRP 352. Grant-free uplink transmissions are sometimes called “grant-less”, “schedule free”, or “schedule-less” transmissions, or transmissions without grant.

During the wireless communication, one or more reference sequences may be transmitted over the wireless channel on one or more reference signals. A reference sequence has values known in advance by the receiving device. The receiving device may use the received reference sequence to perform channel estimation for the channel over which the reference sequence was received. The channel estimation may then be used by the receiving device for decoding information (e.g. control information and/or data) received from the transmitting device on that channel. A reference signal may be transmitted on a portion of time-frequency resources on a multi-carrier symbol or in a single-carrier symbol. The set of time-frequency locations at which one or more reference signals are transmitted may be referred to as the reference signal pattern.

A time domain signal transmission structure may be defined for performing the wireless communication, e.g. to allow for timing reference and timing alignment of basic time domain transmission units. For example, a slot may be defined having a particular duration of time (referred to as a slot duration) in which a particular number of symbols may be transmitted. In some cases, a slot may be defined as a particular number of symbols (e.g. 14 OFDM symbols). The time domain signal transmission structure may be governed by a frame structure.

In some embodiments, different numerologies may be supported, each corresponding to a different subcarrier spacing (SCS). The symbol duration is dependent upon the numerology or SCS. For example, the lower the SCS, the longer the symbol duration. The slot duration and/or a frame duration (if applicable) might or might not depend upon the numerology. In one example, for 15 kHz SCS a slot is defined as having a duration of 1 ms, and for 30 kHz SCS a slot is defined as having a duration of 0.5 ms.

When the UEs wirelessly communicate with the TRP 352, time synchronization of communications arriving from multiple UEs may be desired. For example, the TRP 352 may wish to ensure that the uplink communications from UEs 110x, 110y, and 110z all arrive at the TRP 352 time-aligned with each other, e.g. to ensure that the downlink and uplink slots and/or symbols are synchronized at the TRP 352. However, UEs 110x, 110y, and 110z are typically at different locations relative to the TRP 352, such that each UE 110x, 110y, 110z may have a different signal propagation delay to/from the TRP 352. In the absence of a timing synchronization mechanism, the uplink transmissions from the different UEs 110x, 110y, 110z will typically not arrive at the TRP 352 at the same time because of the varying propagation delays.

A timing advance (TA) value is a time offset that may be applied by a UE 110 to compensate for the propagation delay of that UE 110 and thereby cause that UE's uplink transmissions to be time synchronized with the uplink transmissions of other UEs. The TRP 352 may provide a respective TA value to each UE 110 that is dependent upon that UE's propagation delay, e.g. dependent upon the round trip time (RTT) for that UE. Different UEs may therefore have different TA values. Each UE 110 may apply a negative time offset between the start of a received downlink time and a transmitted uplink time, where the negative time offset is based on the TA value. The TA value may be computed by the TRP 352, e.g. using a preamble transmitted by the UE 110, and then the TA value may be provided to the UE 110 for use by the UE 110 to perform the negative offset. The TA value may be provided in higher-layer signaling, e.g. in a MAC CE. In embodiments described herein, a TA value may additionally or instead be provided in dynamic signaling.

### RS Protection and TA in FD Transmission

As stated above, for a node (e.g. apparatus or device in a wireless network) that supports full duplex (FD) transmissions, a transmission signal may be a self-interference signal to a reception signal, e.g. due to signal leakage (such as over a leakage channel) at the transmission side of the node. To more effectively detect and appropriately detect the actual reception signal (reception signal not affected by the self-interference), it is often desirable to keep reference signals (RSS), which are employed in the transmission signal at the transmission side of the node, uncontaminated by an incoming reception signal from other nodes so that the leakage channel may be more accurately estimated using the reference signals.

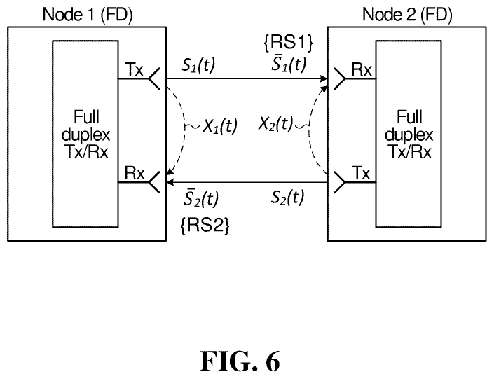

FIG. 6 illustrates an example network with two nodes supporting FD operation mode where RSs are employed for channel estimation. Each of Node 1 and Node 2 may be any of wireless nodes described above such as TRP 352, T-TRP (e.g. T-TRP 170, fixed base station), NT-TRP (e.g. NT-TRP 172, mobile base station such as drone BS), device, CPE (customer premise equipment), UE 110 and/or sensing node. Both of Node 1 and Node 2 may support FD operation mode as indicated in FIG. 6. Alternatively, only one of the Node 1 and the Node 2 may operate in the FD mode. For example, in another scenario not illustrated in FIG. 6 only Node 1 can operate in FD mode while Node 2 operates in half-duplex (HD) mode. At each of Node 1 and Node 2, there is a leakage channel due to FD operation mode and a resulting signal having self-interference.

Referring to FIG. 6, Node 1 may simultaneously transmit a transmission signal S₁(t) to Node 2 and receive a reception signal S₂(t) from Node 2. One or more reference signals {RS1} are employed in the transmission signal S₁(t) at the transmission side of Node 1. The reference signals {RS1} are needed to estimate the leakage channel for the self-interference signal X₁(t) at the transmission side of Node 1. Reference signals {RS1} are also used at the reception side of Node 2 to estimate channels and detect the signal S̅₁(t). Similarly, Node 2 may simultaneously transmit a transmission signal S₂(t) to Node 1 and receive a reception signal S₁(t) from Node 1. One or more reference signals {RS2} are employed in the transmission signal S₂(t) at the transmission side of Node 2. The reference signals {RS2} are needed to estimate the leakage channel for the self-interference signal X₂(t) at the transmission side of Node 2. Reference signals {RS2} are also used at the reception side of Node 1 to estimate channels and detect the signal S̅₂(t).

In cases where, for example, only Node 1 is operating in FD mode and Node 2 is operating in HD mode, Node 1 transmits the signal S₁(t) to a node other than Node 2 while Node 1 is receiving the signal S₂(t) from Node 2 and receives the signal S₂(t) from another node other than Node 2 while Node 1 is transmitting the signal S₁(t) to Node 2. This is because Node 2 operates in HD mode so that Node 2 cannot simultaneously transmit signals to Node 1 and receive signals from Node 1.

In some cases, one node operating in FD mode may transmit multiple signals simultaneously, for example through multiple beams or multiple-input multiple-output (MIMO) transmissions. In such cases, it may be desired to protect all RSs employed in these transmission signals at the transmission side of the node, in order to for example more accurately estimate the leakage channels and self-interference signals thereby possibly measuring overall cancellations associated with all received signals.

In some embodiments, the present disclosure addresses how to protect RSs employed in the transmission signals without interference (e.g. self-interference) by reception signals from other nodes, when only one of the nodes (e.g. Node 1) is operating in FD mode and when both nodes (e.g. Node 1 and Node 2) are operating in FD mode.

The present disclosure provides apparatuses and methods for protecting a reference signal and adjusting timing advance (TA) values to be used for timing synchronization in FD transmission, thereby possibly enhancing FD transmissions in wireless networks. Some embodiments of the present disclosure may provide that both nodes participating in the transmission (e.g. UE and BS) jointly configure reference signals for both transmission and reception signals such that the reference signals may be protected and interference by reception signals from other nodes may be avoided or mitigated. The reference signals may be employed in the transmission signals at the transmission side of the node operating in FD mode.

In a wireless network, for example in a current time division duplex (TDD) network, downlink (DL) RS signals, such as demodulation reference signal (DMRS), from a BS may be utilized for channel estimation at a UE side. In such circumstance, interference to the DL RS signal may be no significant concern at the transmission side or the BS side. The current timing alignment for DL and uplink (UL) transmissions at the BS side may be based on timing advance (TA) signalling for UE UL transmissions, and the current TA granularity is 0.52 us and may be indicated by a medium access control (MAC) control element (CE) or radio resource control (RRC) signaling. However, such a TA adjustment scheme may not be able to meet requirements for FD transmissions in future wireless networks in terms of TA granularity due to, for example, slow timing adjustment indication (e.g. MAC CE indication, RRC signaling) for symbol alignments. The slow timing adjustment indication may not be desirable especially for network transmissions using symbols with durations as short as 1 μs, such as new radio (NR) orthogonal frequency division multiplexing (OFDM) symbol with subcarrier spacing (SCS) of 960 kHz.

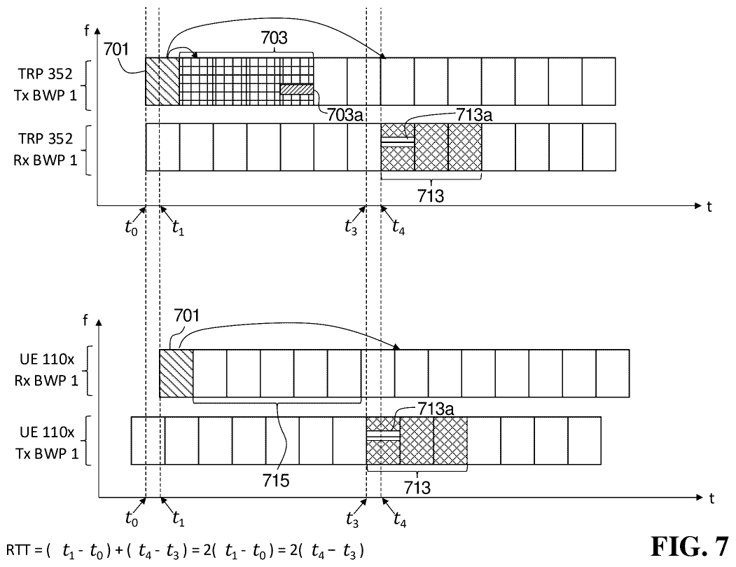

FIG. 7 illustrates an example timing advance (TA) applied based on a round trip time (RTT) between a TRP and a UE in a division duplex (TDD) network, where the TRP and the UE are operating in HD TDD mode. Referring to FIG. 7, the TRP 352 and UE 110x wirelessly communicate over particular frequency resources which, in the illustrated example, is a BWP labeled as BWP 1. The transmissions and receptions are not illustrated on top of each other for clarity, but in general they may be on the exact same frequency resources or the same system channel bandwidth, e.g., 100 MHz. The TRP 352 transmits a downlink transmission of symbols beginning at time t₀. The downlink transmission is performed on a physical downlink control channel (PDCCH) 701, and the downlink transmission is received by the UE 110x beginning at time t₁. The downlink transmission schedules an uplink transmission on physical uplink shared channel (PUSCH) 713 to be sent by UE 110x. The downlink transmission may also schedule another downlink transmission on physical downlink shared channel (PDSCH) 703 to be sent to another UE 110a, as shown in FIG. 7. The other downlink transmission for the other UE 110a on the PDSCH 703 may have a reference signal 703a employed therein. The uplink transmission on the PUSCH 713 may employ the RS 713a therein, and the uplink transmission is scheduled to be received at TRP 352 beginning at time t₄ to be synchronized in time with the receipt of uplink transmissions from other UEs (e.g. UE 110a). The UE 110x applies a TA value dependent upon the RTT to begin transmitting its uplink transmission at time t₃. Hence, provided there is a minimum transition gap 715 (minimum time needed for transitioning between UL and DL transmissions), the uplink transmission to be received at TRP 352 via the PUSCH 713 may be scheduled in consideration of RTT and the minimum transition gap 715. The RTT in this example is (t₄−t₃)+(t₁−t₀). Assuming the time for uplink transmission and downlink transmission are same, the RTT may be estimated using one of uplink and downlink transmissions. In this example, the RTT may be estimated as 2×(t₄−t₃) or 2×(t₁−t₀).

In some embodiments, the present disclosure addresses how to make faster and finer timing alignment on both transmission and reception signals, when only one node in the transmission (e.g. base station (BS)) operates in FD mode and when both nodes in the transmission (e.g. both BS and UE) operate in FD mode.

In some embodiments, both nodes participating in the transmission (e.g. UE, BS, TRP, and any other wireless access nodes) jointly configure reference signals (e.g. DMRS) in a shared spectrum or a sub-band (e.g. bandwidth part (BWP)) so that the reference signals may be protected and interference at the transmission side of the node by reception signals from other nodes may be avoided or mitigated. For instance, self-interference may be more effectively and more accurately estimated and self-interference cancellation (SIC) may be made at the transmission side of the node that is operating in FD mode. Specifically, some protection areas may be reserved or some portion of time-frequency resources associated with DL and UL RS signals may be punctured or rate-matched in both transmitting and receiving directions. In the present disclosure, a network node or a node may be understood as a UE, a BS, a TRP or any other wireless access node. In the present disclosure, while an apparatus is illustrated as being a UE and a device is illustrated as being a BS or a TRP, it should be noted that each of the apparatus and the device may be a UE, a BS, a TRP or any other wireless access node. Put another way, methods illustrated in the present disclosure may be applied to various types of communication links, such as BS-UE access (Uu) link, UE-UE sidelink (SL), and/or access node-access node wireless backhaul (Un) link. In the present disclosure, puncturing may be understood as, for example, refraining from transmitting on some portion of time-frequency resources such that nothing is transmitted on a punctured portion of time-frequency resources. Indicating certain resources to be punctured may involve indicating that such resources are to be used with a certain coding/modulation scheme, rate matching, and/or resource element (RE) nulling. In the present disclosure, rate-matching may be understood as, for example, discarding certain encoded bits (e.g. redundant data bits) to result in a data transmission equivalent to the remaining unpunctured time-frequency resources.

In some embodiments, a FD transmission in a wireless network is enhanced through faster and finer timing adjustment or alignment of both transmission and reception signals. The faster and finer timing alignment may be achieved using dynamic indication on timing alignment (e.g. symbol alignment and/or advancing timing adjustment), for example by sending TA information using dynamic signaling such as DCI (possibly in conjunction with higher-layer signaling). The dynamic indication scheme may be used instead of or in addition to timing adjustment (e.g. timing advance (TA) adjustment) using medium access control (MAC) control element (CE) or radio resource control (RRC) signaling. Frequencies and configurations associated with timing adjustment or alignment for nodes in FD operation mode may depend on numerology, cell radius/size, and/or frequency band.

In some embodiments, in order to reduce signalling overhead and power consumption, grant-free (GF) transmission and reception may be applied to some static devices and/or apparatuses (e.g. static industrial internet-of-thing (IIoT)) in FD operation mode.

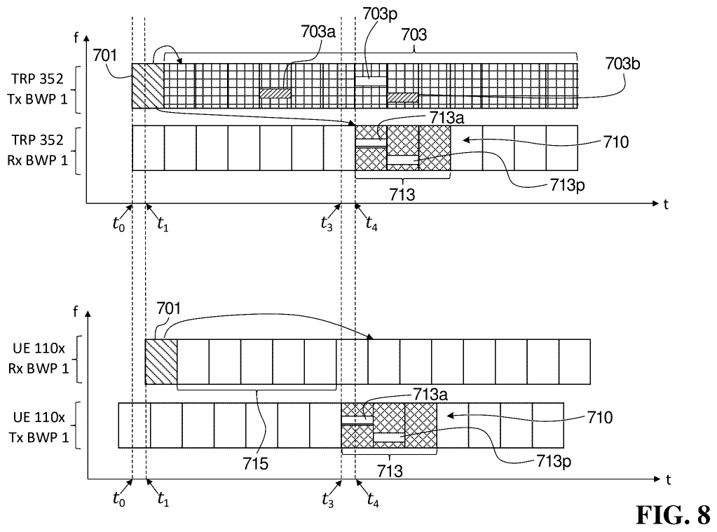

According to some embodiments of the present disclosure, there may be provided, in a wireless network, a device (e.g. BS) operating in FD mode and one or more apparatuses operating in HD mode. The one or more apparatuses (e.g. UE 110x in FIG. 8) may receive, from the device, information indicating a first portion of time-frequency resources to be punctured by the apparatus in a transmitting direction of the apparatus (e.g. UL transmission direction) in order to avoid or mitigate interference of one or more RS signals transmitted from the device (e.g. DL RS transmitted from a BS to a UE), where the apparatuses may also be configured to transmit one or more RS signals (e.g. DMRS) to the device (e.g. UL transmission). This is illustrated in FIG. 8 as one example.

FIG. 8 illustrates a method for protecting a reference signal and adjusting timing advance (TA) in a network with the TRP 352 operating in FD mode and the UE 110x operating in HD mode, according to embodiments of the present disclosure. Referring to FIG. 8, the TRP 352 and UE 110x wirelessly communicate over particular frequency resources which, in the illustrated example, is a BWP labeled as BWP 1 within a system channel bandwidth. The transmissions and receptions are not illustrated on top of each other for clarity, but in general they may be within a system channel bandwidth on the exact same frequency resources or overlapping frequency resources for transmissions and receptions.

The TRP 352 may schedule DL transmission to the UE 110a (not shown in FIG. 8), on the PDSCH 703. The DL transmission to the UE 110a may have the DL RS 703a and the DL RS 703b employed therein. While the TRP 352 is transmitting the DL RS 703a and/or the DL RS 703b, the TRP 352 intends to receive nothing on the time-frequency location at which the DL RS 703a and/or the DL RS 703b are sent. To achieve this, the portion(s) of time-frequency resources in an uplink transmission from a UE that corresponds to the time-frequency location of DL RS 703a and/or the DL RS 703b needs to be punctured by the UE. Hence, the information indicating the first portion 713p of time-frequency resources to be punctured by the UE 110x for a UL transmission needs to be transmitted to the UE 110x. The information indicating the first portion 713p of time-frequency resources to be punctured, in other words, indicates, to the UE 110x, the time-frequency locations at which the DL RS 703a and/or the DL RS 703b are sent and the UE 110x is instructed to avoid any UL transmission.

In some embodiments, the first portion 713p of the time-frequency resources may be punctured by the UE 110x in an UL transmission in order to protect a RS 703b transmitted by the TRP 352, as illustrated. In addition or alternatively, the first portion 713p may be punctured to protect higher priority traffic (DL or UL), sensing signals (DL or UL), control signals, group based or UE specific synchronization signals, and/or other RSs (e.g. network broadcasting signals, paging signals, DL or UL beam pilot signals). The use of the first portion 713p by the TRP 352 may or may not be transparent to the UE 110x and other devices and/or apparatuses, e.g. the UE 110x might not know that the TRP 352 is transmitting RS 703b to UE 110a at that time-frequency location. In some embodiments, a portion 703p of the time-frequency resources may be punctured by the TRP 352 to protect a RS 713a in UL transmission from the UE 110x to the TRP 352.

The TRP 352 transmits, to the UE 110x, information indicating the first portion 713p of time-frequency resources to be punctured for a UL transmission. The information indicating the first portion 713p is transmitted by the TRP 352 beginning at time t₀ and is received by the UE 110x beginning at time t₁.

The information indicating the first portion 713p of time-frequency resources to be punctured may be transmitted on the PDCCH 701. While the PDCCH 701 is used in FIG. 8 for transmission of the information indicating the first portion 713p to be punctured, in some other embodiments, another control channel may be used for example, a sidelink control channel, or a group-cast channel, or a broadcast channel. The information indicating the first portion 713p to be punctured may include first information indicative of one or more symbols corresponding to the first portion 713p and/or second information indicative of one or more frequency locations corresponding to the first portion 713p. In some embodiments, the information indicating the first portion 713p to be punctured may be included in a downlink control information (DCI) or in a sidelink control information (SCI). In some embodiments, the information indicating the first portion 713p to be punctured may additionally or instead be provided in higher layer signaling, e.g. in RRC signaling, or in a MAC CE.

In addition or alternatively, the TRP 352 may transmit, to the UE 110x, an indication to send a reference signal, RS 713a, in the UL transmission on a symbol included in the second portion 710 of the time-frequency resources. The information indicating the symbol and/or frequency location at which the UE 110x is to send the RS 713a may be transmitted on the PDCCH 701, together with the information indicating the first portion 713p to be punctured, beginning at time t₀ and is therefore also received by the UE 110x beginning at time t₁. While FIG. 8 illustrates that the RS 713a and the RS 703a/703b are in a different symbol, in some other cases the RS 713a and the RS 703a or 703b may be located in the same symbol.

The UE 110x, upon receiving from the TRP 352 the information indicating the first portion 713p of time-frequency resources to be punctured, punctures the first portion 713p of time-frequency resources for the UL transmission. The UE 110x sends, to the TRP 352, the UL transmission on a second portion 710 of the time-frequency resources beginning at time t₃ for example via the PUSCH 713. Time t₃ needs to be at least the minimum transition gap 715 after receipt of the information indicating the first portion 713p is complete. The second portion 710 of the time-frequency resources excludes the punctured first portion 713p of the time-frequency resources. The punctured first portion 713p corresponds to the time-frequency location at which the DL RS 703b is transmitted to the UE 110a. The second portion 710 of the time-frequency resources may include the RS 713a on the time-frequency location (e.g. symbol and/or frequency location) specified in the indication from the TRP 352. Put another way, the UE 110x sends the RS 713a in its UL transmission, in accordance with the indication from the TRP 352.

The TRP 352 receives, from the UE 110x, the second portion 710 of the time-frequency resources excluding the punctured first portion 713p beginning at time t₄. If the second portion 710 of the time-frequency resources includes the RS 713a, the TRP 352 also needs to puncture or rate-match the time-frequency location in the downlink corresponding to the time-frequency location at which the RS 713a is sent during the UL transmission of the UE 110x through the PUSCH 713. This punctured time-frequency location is illustrated in FIG. 8 as the punctured portion 703p.

In the present disclosure, only one RS (e.g. DL RS 703a, DL RS 703b, DL RS 1203a, DL RS 1203b, UL RS 713a in FIGS. 8-9 and 12-13) is transmitted and received over only one symbol for clear illustration of the present invention. However, it should be noted that, in some cases, one or more RSs may be transmitted and received over more than one symbol. More than one RS may be transmitted and received over one symbol in duration. In any case, all portions of the time-frequency resources corresponding to time-frequency location(s) at which one or more RS signals are transmitted and/or received in either direction (e.g. transmitting and/or receiving direction; UL and/or DL) may need to be punctured to protect RS signals in FD operation. Put another way, the time-frequency location to be punctured (e.g. punctured portions 703p, 713p, 1203p in FIGS. 8-9 and 12-13) for protection of RS (e.g. DL RS 703a, DL RS 703b, DL RS 1203a, DL RS 1203b, UL RS 713a in FIGS. 8-9 and 12-13) may be more than one symbol, if the RS is transmitted and/or received for more than one symbol period of time.

In some embodiments, to keep both transmission and reception signals being time-aligned such that a device (e.g. TRP 352) is slot-aligned or symbol-aligned, timing alignment adjustment (e.g. symbol timing adjustment, TA adjustment) for UL transmission may be dynamically indicated. The timing alignment adjustment may be specific to each apparatus (e.g. UE 110), as each apparatus (e.g. UE 110) may have different RTT or distance to the device (e.g. TRP 352), for example, depending on its location. Hence, in the case of FIG. 8, the TRP 352 may transmit, to the UE 110x, one or more indications for TA adjustment to be applied to the UL transmission using higher layer signaling and/or DCI signaling (possibly along with the UL transmission scheduling). For example, The TRP 352 may transmit, to the UE 110x, in higher layer signaling, an indication of a first TA adjustment to be applied to the UL transmission, and may also transmit, to the UE 110x in DCI, an indication of a second TA adjustment to be applied instead of or in addition to the first TA adjustment. In some embodiments, the first TA adjustment may be a set of TA adjustment indications that the indication of the second TA adjustment in DCI may choose, or a set of crude TA indications which may be further adjusted and refined using the indication of the second TA adjustment in DCI. In some embodiments, the indication of the second TA adjustment may provide one or more TA adjustment parameters independently. The indication of the second TA adjustment may be utilized for the timing alignment adjustment in multiple ways. The indication of the second TA adjustment may directly provide one or more TA adjustment parameters which may contain absolute values. The indication of the second TA adjustment may be selected from a set of the TA adjustment indications (i.e. first TA adjustment indications) configured by higher layer signaling (e.g. RRC signaling). The indication of the second TA adjustment may be utilized to further adjust and refine the first TA adjustment (e.g. crude TA indications) configured by higher layer signaling (e.g. RRC signaling).

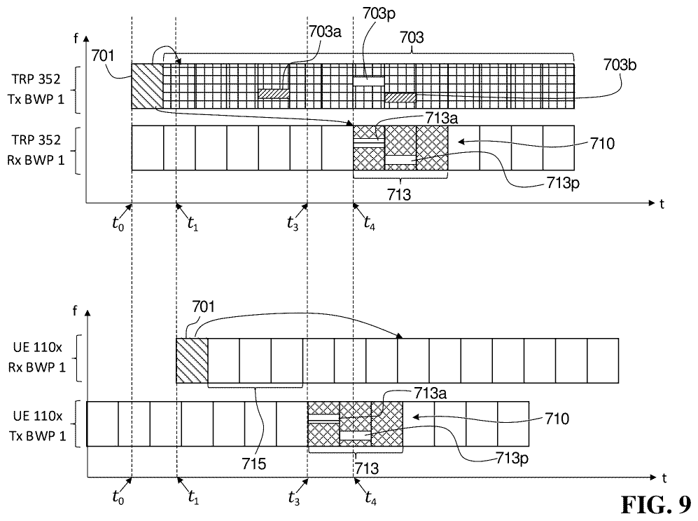

For further illustration about TA adjustment, there is provided FIG. 9. FIG. 9 illustrates a method for protecting a reference signal and adjusting TA in a network with a TRP operating in FD mode and a UE operating in HD mode, where the RTT between the TRP 352 and the UE 110x is large (e.g. greater than one symbol in duration), according to embodiments of the present disclosure. FIG. 9 illustrates an example transmission between the TRP 352 and the UE 110x substantially similar to the transmission illustrated in FIG. 8 but with greater RTT between the TRP 352 and the UE 110x (e.g. greater distance between the TRP 352 and the UE 110x).

In FIG. 9, the UE 110x has a large RTT=(t₄−t₃)+(t₁−t₀) such that the TA value (t₄−t₃) is more than one symbol length due to, for example, mobility of the UE 110x and large cell size associated with the TRP 352. The UE 110x may be remote from the TRP 352, which may result in large RTT delay. On the other hand, the symbol time length may depend on the numerology used in the orthogonal frequency division multiplexing (OFDM) signals. The relationship between subcarrier spacing (SCS), symbol duration, and the distance between the UE and TRP (e.g. BS) is illustrated below in Table 1. In Table 1, SCS is indicative of subcarrier spacing, T_s is indicative of symbol duration with normal cyclic prefix (NCP) and UE-TRP is indicative of the distance between UE and TRP (e.g. BS).

TABLE 1

| SCS (kHz) | 15 | 30 | 60 | 120 | 480 | 960 |
|---|---|---|---|---|---|---|
| T_s (μs) | 71.35 | 35.68 | 17.84 | 8.92 | 2.23 | 1.11 |
| UE-TRP (m) | 10702.5 | 5352 | 2676 | 1338 | 334.5 | 166.5 |

As is clear from Table 1, the symbol duration may be small in some scenarios, which may result in a TA that is more than one symbol, like is the case in FIG. 9.

In some embodiments, the time-frequency resources may be configured only in support of devices (e.g. TRP, BS) in FD operation mode. In order to dynamically indicate timing alignment adjustment (e.g. TA adjustment) for both UL and DL transmissions at a device (e.g. TRP, BS) such that the device is slot-aligned or symbol-aligned, apparatus specific signaling (e.g. UE specific signaling) may be utilized. In some embodiments, apparatus specific higher layer signaling and/or apparatus specific dynamic signaling (e.g. DCI signaling, SCI signaling) may be utilized for faster and finer timing alignment adjustment. The apparatus specific higher layer signaling and/or the apparatus specific dynamic signaling (e.g. DCI signaling, SCI signaling) may be received, by the apparatus, from the device (e.g. BS, TRP). In such embodiments, for example, timing alignment adjustment granularity (e.g. time step size) may be smaller than 0.52 us, and/or dependent on numerology or symbol duration (e.g. 1% of symbol duration). Also, timing alignment adjustment rate or frequency may be associated with the RTT between the device and the apparatus (e.g. between the TRP 352 and the UE 110x in FIGS. 8 and 9).

In some embodiments, the information indicating the portion of the time-frequency resources to be punctured or rate-matched (e.g. the first portion 713p in FIGS. 8 and 9) in the time-frequency resources may be transmitted to an apparatus (e.g. UE 110x in FIGS. 8 and 9) using DCI signaling with a newly defined parameter (e.g. full duplex radio network temporary identifier (FD-RNTI), such as the DCI having its cyclic redundancy check (CRC) scrambled by the FD-RNTI). The information may include locations of one or more punctured symbols in one or more configurable slots and locations of resource elements (REs) within the BWP. The punctured symbol locations and RE locations may be indicated in a form of bitmap.

In some embodiments, the information indicating the portion of the time-frequency resources to be punctured or rate-matched (e.g. the first portion 713p in FIGS. 8 and 9) in the time-frequency resources may be transmitted to a group of apparatuses (e.g. a group of UEs 110x, 110y, and 110z in FIG. 5) using group-cast signaling with a newly defined parameter (e.g. full duplex radio network temporary identifier (FD-RNTI) for the group, such as the DCI having its CRC scrambled by the FD-RNTI). Using the group-cast signaling, the information indicating the portion of the time-frequency resources to be punctured or rate-matched may be transmitted to all apparatuses in the group in a single group-cast transmission, thereby reducing signaling. The information may include locations of one or more punctured symbols in one or more configurable slots and locations of resource elements (REs) within the BWP. The punctured symbol locations and RE locations may be indicated in a form of bitmap.

In some embodiments, the time-frequency resources may be configured by one or a combination of the information indicating the portion of the time-frequency resources punctured or to be punctured (e.g. the first portion 713p in FIGS. 8 and 9) or another signaling. The information indicating the portion of the time-frequency resources punctured or to be punctured and/or the other signaling may be included in at least one of: a higher-layer signaling (e.g. RRC signaling), a dynamic signaling (e.g. DCI signaling), or a preconfiguration (e.g. pre-defined configuration) by the network. An apparatus (e.g. UE 110x in FIGS. 8 and 9) may be informed via a DCI singling that a certain portion (e.g. first portion 713p in FIGS. 8 and 9) is punctured or rate-matched in its received signals. The possibly newly defined parameter (e.g. FD-RNTI), if applicable, and the corresponding control resource set (CORESET) to monitor the associated DCI signaling may be configured by a higher-layer signaling (e.g. RRC signaling) or may be preconfigured or predefined by the network.

In some embodiments, where an apparatus (e.g. UE) has information indicative of the time-frequency location of the RS(s) to be transmitted and/or received by the device (e.g. TRP, BS) in the time-frequency resources, the apparatus may puncture the portion of time-frequency resources on one or more symbols transmitted by the apparatus that together overlap with the symbol at which a RS is transmitted and/or received, without receiving, from the device (e.g. BS, TRP), the information indicating the portion of the time-frequency resources punctured or to be punctured.

It may be noted that in some embodiments some portion of time-frequency resources cannot be punctured. For example, some portion of time-frequency resources may need to be reserved for a device (e.g. BS, TRP) or an apparatus (e.g. UE) as system information is to be transmitted or received on that portion of the time-frequency resources. As such, another node (e.g. UE, BS, TRP) may not be allowed to transmit a RS on that portion of the time-frequency resources (to avoid interference to the system information); or that portion of the time-frequency resources is intended for higher priority transmissions and may not be punctured.

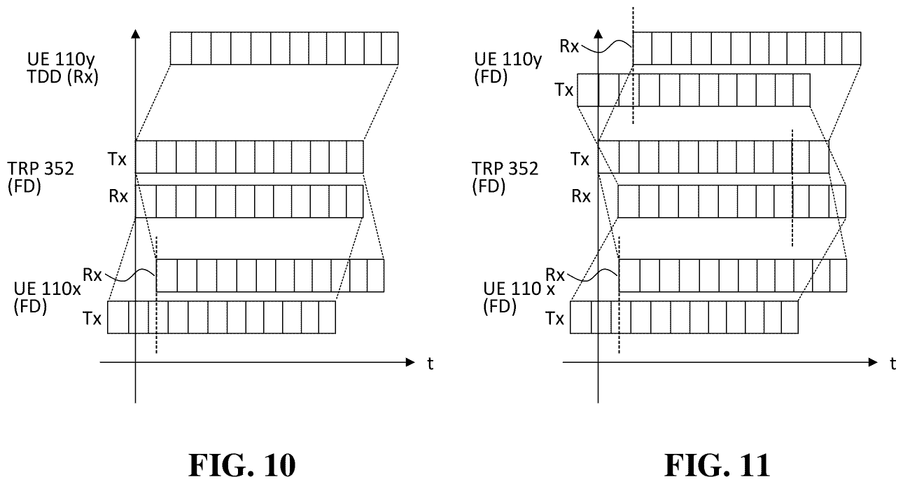

There may be a wireless network where a device (e.g. BS, TRP) is operating in FD mode and one or more apparatuses (e.g. UE) are also operating in FD mode. The one or more apparatuses in FD mode can transmit and receive traffic simultaneously using the same (shared) spectrum or sub-band (BWP) in a system channel bandwidth of a frequency band. In this case, timing alignment for transmission and reception signals at the device (e.g. BS, TRP) may be provided using the timing alignment indication method illustrated above. On the other hand, timing alignment for transmission and reception signals at the apparatuses (e.g. UE) may be not guaranteed and practically not possible, due to unpredictable locations of the apparatuses (e.g. UE) with respect to the device (e.g. BS, TRP). In a network, there may be a constraint to maintain and/or guarantee time synchronization at the device side. As such, each apparatus may need to apply a TA value based on the RTT between the device and the apparatus, and as a result of applying this TA value the timing alignment at the apparatus may not be guaranteed, as the distance between the device and the apparatus varies depending on the location of the apparatus with respect to the device. The timing alignments at the device and the apparatuses are illustrated in FIGS. 10 and 11.

FIGS. 10 and 11 illustrate timing alignments for transmissions between the TRP 352 and the UEs 110x and 110y in a network where the TRP 352 and the UE 110x are operating in FD mode, according to embodiments of the present disclosure. The UE 110y is operating in HD TDD mode (showing only reception side) in FIG. 10 and operating in FD mode in FIG. 11. As illustrated in FIGS. 10 and 11, the TRP 352 is slot-aligned or symbol-aligned but the UEs 110x and 110y are not guaranteed for such slot-alignment or symbol-alignment, for example due to unpredictable location of the UEs 110x and 110y (especially with respect to the TRP 352).

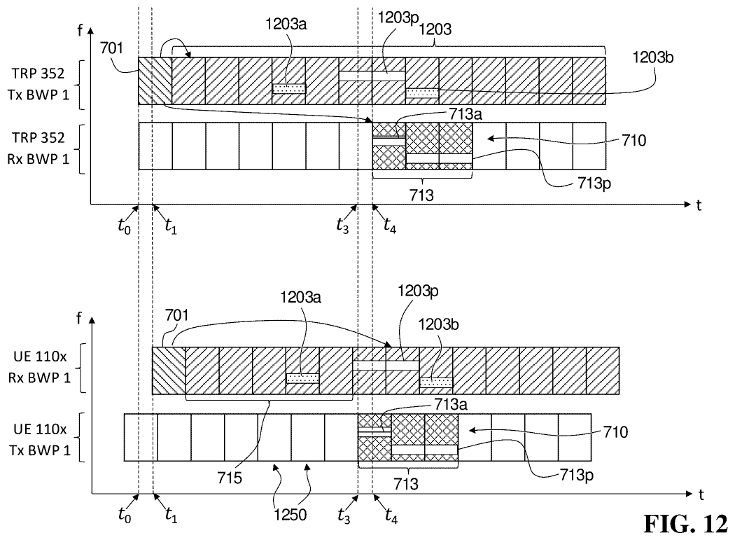

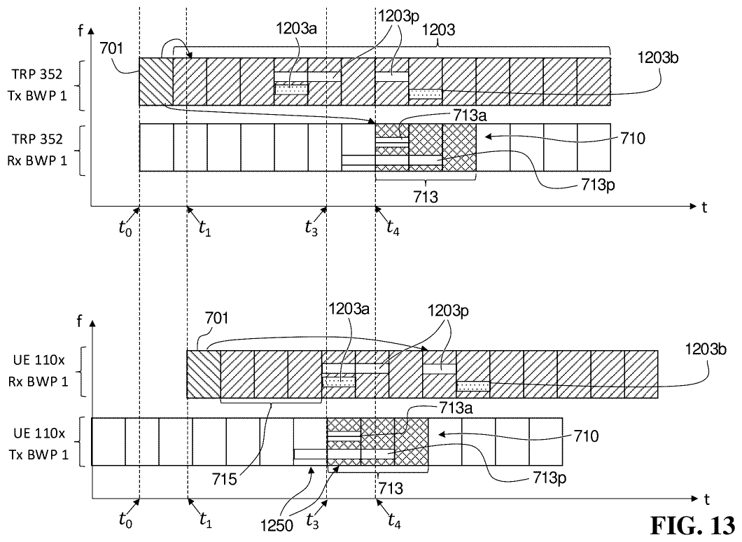

Therefore, in a network where both a device (e.g. BS, TRP) and an apparatus (e.g. UE) are both operating in FD mode, timing misalignment between DL reception and UL transmission at the apparatus (e.g. UE) side may need to be considered, for example when both nodes participating in the transmission (e.g. UE and BS/TRP) jointly configure reference signals for both transmission and reception signals such that the reference signals may be protected and interference by reception signals from other nodes may be avoided or mitigated. In some embodiments, such timing misalignment may be compensated at the apparatus (e.g. UE) side and/or at the device (e.g. TRP/BS) side by puncturing or rate-matching the time-frequency resources at more symbol(s) in both receiving and transmitting directions, such that the punctured (one or more) symbols of the time-frequency resources together overlap with the symbol at which the RS is transmitted by the apparatus (e.g. UE) and/or the symbol at which the RS from the device (e.g. BS, TRP) is sent. The punctured symbols may be punctured at the same frequency locations as the RSs are sent and/or received. In some embodiments, some or all of the punctured symbols are adjacent each other. Protection of transmission RS signals in FD operation at the transmission side is discussed below. Given slot-alignment or symbol-alignment at the device (e.g., BS, TRP, or UE for sidelink) side in FD operation mode, when a RS is to be sent by the device in a certain symbol at a certain frequency location, an apparatus (e.g., UE, or BS for wireless backhaul) may need to puncture a portion of time-frequency resource corresponding to time-frequency location at which the RS is to be sent by the device, if the time-frequency resources at that symbol is to be used by the apparatus (e.g., UE, or BS for wireless backhaul). On the other hand, provided that timing misalignment (e.g. slot-misalignment, symbol-misalignment) usually occurs at the apparatus (e.g. UE) side in FD operation, the symbol associated with time-frequency resource location at which the RS is to be sent by the apparatus may be overlapped with two symbols associated with traffic sent from the device (e.g., BS, TRP, or UE for sidelink) and received by the apparatus (e.g. UE, or BS for wireless backhaul). Therefore, the device may need to puncture a portion of time-frequency resources at which the RS is to be sent by the apparatus over the two associated symbols, if the device is to use the resources in the two associated symbols for transmission. Now, protection of reception RS signals in FD operation is discussed below. When performing channel estimation for detecting and decoding the signals received at a node, RS signals received at the node need to be protected in order to avoid or mitigate interference from the transmitting traffic of the node. Due to timing-misalignment (e.g. slot-misalignment, symbol-misalignment) at the apparatus side, a symbol including a portion of time-frequency resources at the receiving side of the apparatus (e.g. UE) where the RS is received by the apparatus from the device (e.g. BS, TRP) may or may not be time-aligned with transmission symbols from the apparatus. Thus, one or more transmission symbols at the apparatus may need to be punctured on frequency locations of the received RS. The one or more transmission symbols overlap with the symbol where the RS is transmitted from other node. While one punctured symbol is enough for when a time-alignment (e.g. slot-alignment, symbol-alignment) is maintained between transmissions and receptions at the apparatus, whereas two neighboring symbols may need to be punctured when a symbol-alignment is not maintained between transmissions and receptions at the apparatus. It is expected that when time-alignment (e.g. slot-alignment or symbol-alignment) is provided at the device (e.g., BS, TRP, or UE for sidelink) side and timing-misalignment (e.g. symbol-misalignment, slot-misalignment) is provided at the apparatus (e.g. UE) side with FD operations, the apparatus and/or device may need to puncture a portion of time-frequency resources over at least two symbols to protect the received RS. If the transmitting-receiving RTT is much smaller than one symbol in duration (depending on the numerology used), the frequency location corresponding to the frequency location of the received RS may be punctured in two neighboring symbols which overlap or associate with the symbol at which the received RS is located at the transmitting side of the apparatus, to protect the received RS. The puncture portion of the time-frequency resources in the two neighboring symbols may protect the RS at the transmitting end of the device as the two neighboring symbols overlap with the symbol in which the RS is located at the transmitting side of the device, as illustrated in FIG. 12. If the transmitting-receiving RTT is greater than one symbol in duration, the frequency locations corresponding to the frequency location of the received RS may be punctured in three (or more) symbols which overlap or associate with the symbol at which the received RS is located at the transmitting side of the apparatus node in order to protect the received RS. The puncture portion of the time-frequency resources in the three (or more) symbols may also protect at the transmitting end of the device as the three (or more) symbols overlap with the symbol in which the RS is located at the transmitting side of the device, as shown in FIG. 13. Time-frequency resources need to be punctured in additional symbols (e.g. more than two symbols) due to large RTT value. In a practical perspective, time-frequency resources may be punctured in (up to) four symbols in time duration to protect one symbol associated with RS transmitted by the device, if none of transmitting device and receiving apparatus are time-aligned (e.g. symbol-aligned, slot-aligned) in transmission and reception.

FIG. 12 illustrates a method for protecting a reference signal and adjusting TA in a network where both the TRP 352 and the UE 110x are operating in FD mode, according to embodiments of the present disclosure. In FIG. 12, the RTT between the TRP 352 and the UE 110x is less than one symbol in duration. Referring to FIG. 12, the TRP 352 and UE 110x wirelessly communicate over particular frequency resources which, in the illustrated example, is a BWP labeled as BWP 1 within a system channel bandwidth of a frequency band. The transmissions and receptions are not illustrated on top of each other for clarity, but in general they may be on the exact same frequency resources.

The TRP 352 may schedule DL transmission to the UE 110x on the PDSCH 1203. The DL transmission to the UE 110x may have the DL RS 1203a and the DL RS 1203b employed therein. While the TRP 352 is transmitting the DL RS 1203a and/or the DL RS 1203b, the TRP 352 needs to receive nothing (or null signals) on the time-frequency location at which the DL RS 1203a and/or the DL RS 1203b are sent. To achieve this, the portion(s) of time-frequency resources in an uplink transmission from a UE that corresponds to the time-frequency location of the DL RS 1203a and/or the DL RS 1203b needs to be punctured by the UE.

Therefore, to support FD operation mode in the TRP 352 and the UE 110x (and other UEs not shown in FIG. 12), the UE 110x may receive, from the TRP 352, information indicating the first portion 713p of time-frequency resources to be punctured by UE 110x in a transmitting direction (e.g. UL transmission direction) to avoid and/or mitigate interference of the DL RS 1203a and/or the DL RS 1203b transmitted by the TRP 352. The information indicating the first portion 713p of time-frequency resources to be punctured, in other words, indicates the time-frequency locations at which the DL RS 1203a and/or the DL RS 1203b are sent.

In some embodiments, the first portion 713p of the time-frequency resources may be punctured by the UE 110x in an UL transmission in order to protect a RS 1203b transmitted by the TRP 352, as illustrated. In addition or alternatively, the information indicating the first portion 713p to be punctured may be used for other purposes, e.g., to protect higher priority traffic (DL or UL), sensing signals (DL or UL), control signals, group based or UE specific synchronization signals, and/or other RSs (e.g. network broadcasting signals, paging signals, DL or UL beam pilot signals). The use of the first portion 713p by the TRP 352 may or may not be transparent to the UE 110x and other devices and/or apparatuses, depending upon the scenario. In some embodiments, a portion 1203p of the time-frequency resources may be punctured by the TRP 352 to protect a RS 713a in UL transmission from the UE 110x to the TRP 352 at a transmitting direction of the UE 110x. The punctured portion 1203p of the time-frequency resources may also protect the RS 713a at a receiving direction of the TRP 352 from interference of the transmitting traffic of the TRP 352. Protection of the RS 713a at the receiving direction of the TRP 352 may be advantageous especially where for example the RS 713a is required to perform channel estimation for detecting/decoding signal received by the TRP 352.

The TRP 352 transmits, to the UE 110x, information indicating the first portion 713p of time-frequency resources to be punctured for a UL transmission. The information indicating the first portion 713p is transmitted by the TRP 352 beginning at time t₀ and is received by the UE 110x beginning at time t₁.

The information indicating the first portion 713p of time-frequency resources to be punctured may be transmitted on the PDCCH 701. While the PDCCH 701 is used in FIG. 12 for transmission of the information indicating the first portion 713p to be punctured, in some other embodiments, another control channel may be used for example, a sidelink control channel, or a group-cast channel, or a broadcast channel. The information indicating the first portion 713p to be punctured may include first information indicative of one or more symbols corresponding to the first portion 713p and/or second information indicative of one or more frequency locations corresponding to the first portion 713p. In some embodiments, the information indicating the first portion 713p to be punctured may be included in a downlink control information (DCI) or in a sidelink control information (SCI). In some embodiments, the information indicating the first portion 713p to be punctured may additionally or instead be provided in higher layer signaling, e.g. in RRC signaling, or in a MAC CE.

In addition or alternatively, the TRP 352 may also transmit, to the UE 110x, an indication to send a reference signal, RS 713a, in the UL transmission on a symbol included in the second portion 710 of the time-frequency resources. One or more symbols included in the time-frequency resources in a receiving direction of the UE 110x may together overlap with said symbol at which the RS 713a is transmitted by the UE 110x. The one or more symbols which together overlap with the symbol at which the RS 713a is transmitted by the UE 110x includes a third portion 1203p of the time-frequency resources in the receiving direction. The third portion 1203p of the time-frequency resources is in the transmission sent by the TRP 352, at a receiving direction of the UE 110x and a transmitting direction of the TRP 352. It is noted that while FIG. 12 illustrates the punctured third portion 1203p in the transmission sent from the TRP 352 to the UE 110x, the TRP 352 may need to puncture the third portion 1203p and/or another portion of the time-frequency resources for transmissions to other apparatuses also or instead. In FIG. 12, there are two symbols in the third portion 1203p. These two symbols together overlap with the symbol that the RS 713a is transmitted at the UE 110x, and overlap with the symbol the RS 713a is received at the TRP 352. The third portion 1203p of the time-frequency resources in the receiving direction of the UE 110x is at the same frequency location as the RS 713a and is punctured to avoid and/or mitigate interference with RS 713a transmitted from the UE 110x. The information indicating the symbol and/or frequency location at which the UE 110x is to send the RS 713a may be transmitted on the PDCCH 701, together with the information indicating the first portion 713p to be punctured, beginning at time t₀ and is therefore also received by the UE 110x beginning at time t₁. While FIG. 12 illustrates that the RS 713a and the RS 1203a/1203b are in a different symbol, in some other cases the RS 713a and the RS 1203a or 1203b may be located in the same symbol.

The UE 110x, upon receiving from the TRP 352 the information indicating the first portion 713p of time-frequency resources to be punctured, punctures the first portion 713p of time-frequency resources for the UL transmission. The UE 110x sends, to the TRP 352, the UL transmission on a second portion 710 of the time-frequency resources beginning at time t₃ for example via the PUSCH 713. Time t₃ needs to be at least the minimum transition gap 715 after receipt of the information indicating the first portion 713p is complete. The second portion 710 of the time-frequency resources excludes the punctured first portion 713p of the time-frequency resources. The punctured first portion 713p corresponds to the time-frequency location at which the DL RS 1203b is transmitted to the UE 110x. The second portion 710 of the time-frequency resources may include the RS 713a on the time-frequency location (e.g. symbol and frequency location) specified in the indication from the TRP 352. Put another way, the UE 110x sends the RS 713a in its UL transmission, in accordance with the indication from the TRP 352. As stated above, the one or more symbols which includes the punctured third portion 1203p together overlaps with the symbol that the UE sends the RS 713a. The frequency location of the punctured third portion 1203p is same as the frequency location of the RS 713a sent by the UE 110X.

The TRP 352 receives, from the UE 110x, the second portion 710 of the time-frequency resources excluding the punctured first portion 713p beginning at time t₄. In FIG. 12, as the second portion 710 of the time-frequency resources includes the RS 713a, the TRP 352 punctures or rate-matches the time-frequency location in the downlink corresponding to the time-frequency location at which the RS 713a is sent during the UL transmission of the UE 110x through the PUSCH 713. This punctured time-frequency location is illustrated in FIG. 12 as the punctured portion 1203p.

In some embodiments, to keep both transmission and reception signals being time-aligned such that a device (e.g. TRP 352) is slot-aligned or symbol-aligned, timing alignment adjustment (e.g. symbol timing adjustment, TA adjustment) for UL transmission may be dynamically indicated by the device based on the RTT between the device (e.g. TRP 352) and the apparatus (e.g. UE 110x). The timing alignment adjustment may be specific to each apparatus (e.g. UE 110), as each apparatus (e.g. UE 110) may have different RTT or distance to the device (e.g. TRP 352) depending on its location. Hence, in the case of FIG. 12, the TRP 352 may transmit, to the UE 110x, one or more indications for TA adjustment to be applied to the UL transmission using higher layer signaling and/or DCI signaling (possibly along with the UL transmission scheduling). For example, The TRP 352 may transmit, to the UE 110x, in higher layer signaling, an indication of a first TA adjustment to be applied to the UL transmission, and may also transmit, to the UE 110x in DCI, an indication of a second TA adjustment to be applied instead of or in addition to the first TA adjustment. In some embodiments, the first TA adjustment may be a set of TA adjustment indications that the indication of the second TA adjustment in DCI may choose, or a set of crude TA indications which may be further adjusted and refined using the indication of the second TA adjustment in DCI. In some embodiments, the indication of the second TA adjustment may provide one or more TA adjustment parameters independently. The indication of the second TA adjustment may be utilized for the timing alignment adjustment in multiple ways. The indication of the second TA adjustment may directly provide one or more TA adjustment parameters which may contain absolute values. The indication of the second TA adjustment may be selected from a set of the TA adjustment indications (i.e. first TA adjustment indications) configured by higher layer signaling (e.g. RRC signaling). The indication of the second TA adjustment may utilized to further adjust and refine the first TA adjustment (e.g. crude TA indications) configured by higher layer signaling (e.g. RRC signaling). In some embodiments, a dynamic indication of timing alignment adjustment (e.g. symbol timing adjustment, TA adjustment) may or may not be signalled or transmitted along with the information indicating the first portion 713p of time-frequency resources to be punctured. In some embodiments, information indicating dynamic indication of timing alignment adjustment, information indicating a portion of time-frequency resources to be punctured, information indicating dynamic scheduling on time-frequency resources at transmitting and/or receiving directions of the apparatus (e.g. UE), or any combination thereof may be transmitted separately or simultaneously.

As stated above, misalignment between transmission and reception signals at apparatuses (e.g. UE 110) is specific to each UE and dependent upon, for example, distance between the device (e.g. TRP 352) and the apparatus (e.g. UE 110x) or RTT. In FIG. 12, puncturing across two symbols is used to compensate the misalignment at the UE 110x, where a symbol in one traffic direction (e.g. UL/DL) may be associated with more than one symbol in the other traffic direction (e.g. DL/UL). For example, as illustrated in FIG. 12, the symbol at which the RS 713a is located (in the transmitting direction of the UE 110x) is associated with more than one symbol in the receiving direction of the UE 110x. This entails that a portion of time-frequency resources needs to be punctured through more than one symbol of the time-frequency resources. In FIG. 12, the third portion 1203p needs to be punctured through more than one symbol of the time-frequency resources at the same frequency location as the RS 713a, as illustrated in the figure. Therefore, in order to support FD operations in both an apparatus (e.g. UE) and a device (BS, TRP), a RS located in one symbol of time-frequency resources in one traffic direction may require a portion of time-frequency resources be punctured in the opposite traffic direction in at least two symbols and at the same frequency location as said RS. Provided that the same numerology being used in both traffic directions, symbol misalignment of transmissions and receptions at the UE (e.g. UE 110x) may result in that two or more symbols in one traffic direction are required to protect RS signal(s) included in one symbol in the other traffic direction. On the other hand, for a symbol-aligned device (e.g. slot-aligned TRP 352), due to the symbol alignment (and also possible slot alignment), one symbol in one traffic direction may be sufficient to protect the RS signal included in one corresponding symbol in the other traffic direction, as illustrated in FIG. 12.

In FIG. 12, the two symbols in which the punctured first portion 713p is included at the transmitting direction of the UE 110x are sufficient to protect the RS 1203b not only at the receiving direction of the UE 110x but also at the transmitting direction of the TRP 352, as the RTT between the TRP 352 and the UE 110x is less than one symbol in duration. However, a portion of time-frequency resources may need to be punctured over more than two symbols if for example the RTT between the TRP 352 and the UE 110x is greater than one symbol in duration. One example of such cases is illustrated in FIG. 13.

FIG. 13 illustrates a method for protecting a reference signal and adjusting TA in a network where both the TRP 352 and the UE 100x are operating in FD mode and the RTT between the TRP 352 and the UE 100x is greater than one symbol in duration, according to embodiments of the present disclosure. FIG. 13 illustrates an example transmission between the TRP 352 and the UE 110x substantially similar to the transmission illustrated in FIG. 12 but with greater RTT between the TRP 352 and the UE 110x (i.e. greater distance between the TRP 352 and the UE 110x).

In FIG. 13, the RTT between the TRP 352 and the UE 110x is greater such that the TA value (t₄−t₃) is more than one symbol in duration due to, for example, mobility of the UE 110x and large cell size associated with the TRP 352. As the RTT between the TRP 352 and the UE 110x is greater than one symbol, a greater portion of the time-frequency resources is needed to be punctured. In the network illustrated in FIG. 13, a portion of the time-frequency resources needs to be punctured in three symbols of duration, as in the case of the first punctured portion 713p and the third punctured portion 1203p, in order to protect the reference signals (i.e. RS 713a, RS 1203a, and RS 1203b) and hence avoid or mitigate interference of signals from the other node. As such, when the TRP 352 transmits, to the UE 110x, information indicating the first portion 713p of time-frequency resources to be punctured for a UL transmission, said information indicating the first portion 713p to puncture may specify that the time length of the first portion 713p of the time-frequency to be punctured is three symbols. The information may also indicate the frequency location of the first portion 713p.

Similarly, as the second portion 710 of the time-frequency resources includes the RS 713a, the TRP 352 punctures or rate-matches the time-frequency location in the downlink corresponding to the time-frequency location at which the RS 713a is sent during the UL transmission of the UE 110x through the PUSCH 713. This punctured time-frequency location is illustrated in FIG. 13 as the punctured portion 1203p. In FIG. 13, while the punctured portion 1203p is split into two parts due to the greater distance between the TRP 352 and the UE 110x (i.e. RTT between the TRP 352 and the UE 110x greater than one symbol in duration), each part of the punctured portion 1203p overlaps with the time-frequency location of the RS 713a either in a transmitting direction at the UE 110x or in a receiving direction at the TRP 352. Put another way, the two parts of the punctured portion 1203p together overlap with the time-frequency location of the time-frequency resources at which the RS 713a is transmitted from the UE 110x to the TRP 352.

As stated above, in some embodiments, to keep both transmission and reception signals being time-aligned such that a device (e.g. TRP 352) is slot-aligned or symbol-aligned, timing alignment adjustment (e.g. symbol timing adjustment, TA adjustment) for UL transmission may be dynamically indicated by the device based on the RTT between the device (e.g. TRP 352) and the apparatus (e.g. UE 110x). The timing alignment adjustment may be specific to each apparatus (e.g. UE 110), as each apparatus (e.g. UE 110) may have different RTT or distance to the device (e.g. TRP 352) depending on its location. Hence, in the case of FIG. 13, the TRP 352 may transmit, to the UE 110x, one or more indications for TA adjustment to be applied to the UL transmission using higher layer signaling and/or DCI signaling (possibly along with the UL transmission scheduling). For example, The TRP 352 may transmit, to the UE 110x, in higher layer signaling, an indication of a first TA adjustment to be applied to the UL transmission, and may also transmit, to the UE 110x in DCI, an indication of a second TA adjustment to be applied instead of or in addition to the first TA adjustment. In some embodiments, the first TA adjustment may be a set of TA adjustment indications that the indication of the second TA adjustment in DCI may choose, or a set of crude TA indications which may be further adjusted and refined using the indication of the second TA adjustment in DCI. In some embodiments, the indication of the second TA adjustment may provide one or more TA adjustment parameters independently. The indication of the second TA adjustment may be utilized for the timing alignment adjustment in multiple ways. The indication of the second TA adjustment may directly provide one or more TA adjustment parameters which may contain absolute values. The indication of the second TA adjustment may be selected from a set of the TA adjustment indications (i.e. first TA adjustment indications) configured by higher layer signaling (e.g. RRC signaling). The indication of the second TA adjustment may utilized to further adjust and refine the first TA adjustment (e.g. crude TA indications) configured by higher layer signaling (e.g. RRC signaling).

In some embodiments, in order to dynamically indicate timing alignment adjustment (e.g. TA adjustment) for both UL and DL transmissions at the device (e.g. TRP 352, BS) such that the device is slot-aligned or symbol-aligned, apparatus specific signaling (e.g. UE specific signaling) may be utilized. In some embodiments, apparatus specific higher layer signaling and/or apparatus specific dynamic signaling (e.g. DCI signaling, SCI signaling) may be utilized for faster and finer timing alignment adjustment. The apparatus specific higher layer signaling and/or the apparatus specific dynamic signaling (e.g. DCI signaling, SCI signaling) may be received, by the apparatus, from the device (e.g. BS, TRP). In such embodiments, for example, timing alignment adjustment granularity (e.g. time step size) may be dependent on numerology or symbol duration (e.g. 1% of symbol duration). Also, timing alignment adjustment rate or frequency may be associated with the RTT between the device and the apparatus (e.g. between TRP 352 and UE 110x in FIGS. 12 and 13).

In some embodiments, the information indicating the portion of the time-frequency resources to be punctured or rate-matched (e.g. the first portion 713p in FIGS. 12 and 13) in the time-frequency resources may be transmitted to an apparatus (e.g. UE 110x in FIGS. 12 and 13) using DCI signaling with a newly defined parameter (e.g. full duplex radio network temporary identifier (FD-RNTI), such as the DCI having its CRC scrambled by the FD-RNTI). The information may include locations of one or more punctured symbols in one or more configurable slots and locations of resource elements (REs) within the BWP. The punctured symbol locations and RE locations may be indicated in a form of bitmap.

In some embodiments, the information indicating the portion of the time-frequency resources to be punctured or rate-matched (e.g. the first portion 713p in FIGS. 12 and 13) in the time-frequency resources may be transmitted to a group of apparatuses (e.g. a group of UEs 110x, 110y, and 110z in FIG. 5) using group-cast signaling with a newly defined parameter (e.g. full duplex radio network temporary identifier (FD-RNTI), such as the DCI having its CRC scrambled by the FD-RNTI). Using the group-cast signaling, the information indicating the portion of the time-frequency resources to be punctured or rate-matched may be transmitted to all apparatuses in the group in a single group-cast transmission, thereby reducing signaling. The information may include locations of one or more punctured symbols in one or more configurable slots and locations of resource elements (REs) within the BWP. The punctured symbol locations and RE locations may be indicated in a form of bitmap.

In some embodiments, the time-frequency resources may be configured by one or a combination of the information indicating the portion of the time-frequency resources punctured or to be punctured (e.g. the first portion 713p in FIGS. 12 and 13) or another signaling. The information indicating the portion of the time-frequency resources punctured or to be punctured and/or the other signaling may be included in at least one of: a higher-layer signaling (e.g. RRC signaling), a dynamic signaling (e.g. DCI signaling, SCI signaling), or a preconfiguration (e.g. pre-defined configuration) by the network. An apparatus (e.g. UE 110x in FIGS. 12 and 13) may be informed via a DCI singling that a certain portion (e.g. first portion 713p in FIGS. 12 and 13) is punctured or rate-matched in its received signals. The possibly newly defined parameter (e.g. FD-RNTI), if applicable, and the corresponding control resource set (CORESET) to monitor the associated DCI signaling may be configured by a higher-layer signaling (e.g. RRC signaling) or may be preconfigured or predefined by the network.

As illustrated above, the number of symbols associated with the portion of time-frequency resources to be punctured may depend on the RTT between a device (e.g TRP, BS) and an apparatus (e.g. UE). In some embodiments where the RTT is greater than one symbol in duration, the portion of the time-frequency resources to be punctured is located on two or more symbols. In other words, two or more symbols may be needed to protect the associated reference signals employed in the signals on the other traffic direction. For example, to protect each of the RS 713a, the RS 1203a, and/or the RS 1203b in FIGS. 12 and 13, portions of the time-frequency resources are punctured on two or more symbols on the counter direction of each reference signal. It should be noted that, in FIGS. 12 and 13, two symbols are needed for protection of the RS 1203a, as the RS 1203a overlaps with two symbols (i.e. both of the symbols 1250) in the transmitting direction of the UE 110x. In FIG. 12, there is no transmission scheduled at the UE 110x over the symbols 1250, hence no puncturing is needed over the symbols 1250. However, if there were transmission scheduled at the symbols 1250, then a portion of the time-frequency resources would need to be punctured at the frequency location of the RS 1203a over the symbols 1250. In FIG. 13, only second half of the symbols 1250 is associated with the UL transmission of the UE 110x, hence a portion of the time-frequency resources is punctured at the frequency location of the RS 1203a over only the second half of the symbols 1250, as illustrated. However, a portion of the time-frequency resources at the frequency location of the RS 1203a needs to be reserved or protected over the first half of the symbols 1250. In some embodiments where the RTT is less than one symbol in duration, the portion of the time-frequency resources to be punctured is located on only one or two symbols. In other words, one or two symbols might only be needed to protect the associated reference signals employed in the signals on the other traffic direction. Although the RTT is less than one symbol in duration, two symbols may still be needed for protection of the reference signals, as the reference signals may overlap with two adjacent symbols on the other traffic direction.

In the embodiments illustrated in FIGS. 12 and 13, the device (e.g. TRP, BS) and the associated apparatuses (e.g. UEs) are operating in FD mode. However, in some other embodiments that are variations of FIGS. 12 and 13, the device (e.g. TRP, BS) and only some of the associated apparatuses (e.g. UEs) are operating in FD mode and other associated apparatuses are operating in HD mode.

In some embodiments, where an apparatus (e.g. UE) has information indicative of the time-frequency location of the RS(s) to be transmitted and/or received by the device (e.g. TRP, BS) in the time-frequency resources, the apparatus may puncture the portion of time-frequency resources on one or more symbols transmitted by the apparatus that together overlap with the symbol at which a RS is transmitted and/or received, without receiving, from the device (e.g. BS, TRP), the information indicating the portion of the time-frequency resources punctured or to be punctured.

It may be noted that in some embodiments some portion of time-frequency resources cannot be punctured. For example, some portion of time-frequency resources may need to be reserved for a device (e.g. BS, TRP) or an apparatus (e.g. UE) as system information is to be transmitted or received on that portion of the time-frequency resources. As such, another node (e.g. UE, BS, TRP) may not be allowed to transmit on that portion of the time-frequency resources (to avoid interference to the system information); or that portion of the time-frequency resources is intended for higher priority transmissions and may not be punctured, too.

### Grant-Free Embodiments

In some embodiments, in order to reduce signalling overhead and power consumption, grant-free (GF) transmission and reception may be applied to some static apparatuses (e.g. static industrial internet-of-thing (IIoT) apparatuses) operating in FD or HD mode. Time-frequency resources associated with the static apparatuses may be semi-statically configured. For example, a set of time-frequency resources may be configured through higher-layer signaling (e.g. RRC signaling) for both transmitting and receiving directions or UL and DL directions, with preconfigured or predefined RS/DMRS patterns. The preconfigured or predefined RS/DMRS patterns may include the associated time-frequency resource portions to be punctured in both transmitting and receiving directions or UL and DL directions.

In some embodiments for example where grant-free (GF) transmission and reception are applied, a portion of time-frequency resources may be punctured based on the periodicity configured with preconfigured or predefined RS/DMRS patterns. For example, a portion of the synchronization signal blocks (SSBs) may be punctured based on the periodicity, for protection of a channel state information reference signal (CSI-RS). When puncturing a portion of time-frequency resources based on the configured periodicity, it may be required to make sure a certain portion of the time-frequency resources is not punctured. The certain portion of the time-frequency resources may need to be protected as, for example, that certain portion of time-frequency resources may need to be reserved for system information that is transmitted on that certain portion of the time-frequency resources. As such, a RS may not be transmitted on that certain portion of the time-frequency resources and therefore that portion of the time-frequency resources may not be punctured, too.

In some embodiments, time-frequency resources associated with the static apparatuses may be configured when the apparatuses are operating in HD mode or FD mode. When the apparatuses are operating in HD mode, the apparatuses may support FD operation of the devices (e.g. TRP, BS). Unlike the static apparatuses, the devices (e.g. TRP, BS) may need to be operated in FD mode.

Pre-configuration for the locations of the RS and the punctured portion of the time-frequency resources may be utilized to support FD operations in the apparatus (e.g. UEs) and the device (e.g. TRP, BS).

Where a static apparatus (e.g. IIOT apparatus) supports GF transmissions and receptions and the apparatus is remotely situated from the device (e.g. large RTT), dynamic indication (e.g. DCI signaling, SCI signaling) for TA adjustment may be not needed. Because the apparatus is static, its TA may not need to be adjusted because the apparatus is not moving.

### Additional Variations, Embodiments, and Methods

To support FD operations for transmissions and receptions in different numerologies, at least two circumstances may be considered—where a device (e.g. TRP, BS) operates in FD mode and where both the device and an apparatus (e.g. UE) operate in FD mode. In either case, a portion of time-frequency resources is punctured to protect RS signals in the other traffic direction from interference. For example where both the device and the apparatus operate in FD mode, a portion of time-frequency resources in one traffic direction (e.g., transmitting direction of the UE) may be punctured to protect RS signals in the other traffic direction (e.g., receiving direction of the UE or traffic direction of transmission from the BS) from interference for self-interfering signal estimation in SIC at the other traffic direction and/or for channel estimation in the reception signal detection/decoding at the apparatus (e.g. UE).

As illustrated above and elsewhere in the present disclosure, a portion of time-frequency resources being punctured may be located on one or more symbols in duration. In some embodiments, a portion of time-frequency resources associated with one transmission link is punctured in more than one symbol to protect the associated RS associated with the other transmission link, even at a slot-aligned device (e.g. slot-aligned BS). In some embodiments:
TA adjustment is needed for an alignment of slot or smallest-SCS symbol;
a symbol with smaller SCS overlaps with more than one symbol having a largest SCS at a slot-aligned/symbol-aligned device (e.g. slot-aligned/symbol-aligned BS, slot-aligned/symbol-aligned TRP) in FD operation mode;
a symbol with smaller SCS overlaps with two or more symbols having a largest SCS at an apparatus (e.g. UE) in FD operation mode; and/or
for some sidelink communications between two or more UEs in FD operation mode, each UE may not be time-aligned between transmission and reception, and therefore a common timing reference may be used;
for some other sidelink communications between two or more UEs in FD operation mode, one UE may be pre-configured or configured as a master UE such that the master UE may operate in time-alignment (e.g. slot-alignment or symbol-alignment) between transmission and reception but the other UE may operate in time-misalignment between transmission and reception, and a timing reference may be provided by the master UE or by another source (e.g. GPS, BS, and/or satellite) and utilized as synchronization/timing reference for the sidelink communications.

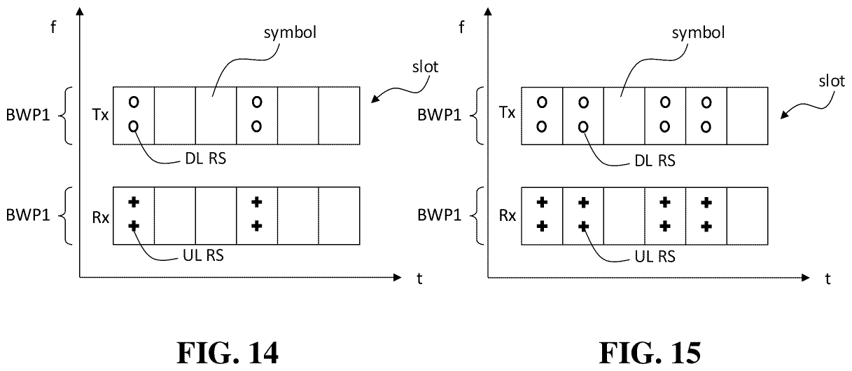

In some embodiments where an apparatus (e.g. UE) transmits and receives orthogonal RSs, the orthogonal RSs and their patterns in both transmitting and receiving directions or both UL and DL directions may be jointly configured, as illustrated for example in FIGS. 14 and 15. FIG. 14 illustrates DL and UL transmissions with orthogonal RS signals over code division multiplexing (CDM) and symbol/slot alignment, according to embodiments of the present disclosure. FIG. 15 similarly illustrates DL and UL transmissions with orthogonal RSs over cover code and symbol/slot alignment, according to embodiments of the present disclosure.

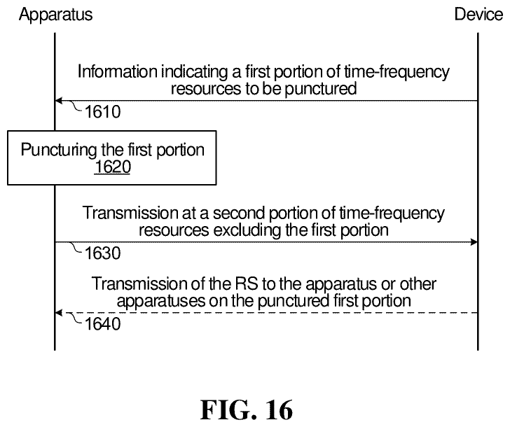

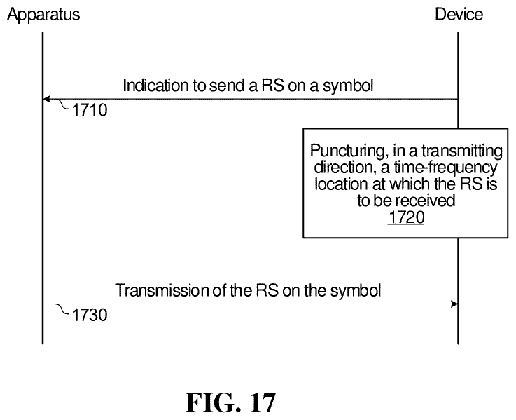

FIGS. 16 and 17 illustrate methods performed by an apparatus and a device, according to embodiments of the present disclosure. In FIGS. 16 and 17, the device may be a BS or a TRP, and the apparatus may be a UE. The device may operate in FD mode, and the apparatus may operate in FD mode or HD mode.

At step 1610, the apparatus receives, from the device, information indicating a first portion of time-frequency resources to be punctured for a transmission of the apparatus. The apparatus may receive the information indicating to the apparatus the first portion of the time-frequency resources in a control channel. The control channel may be a physical downlink control channel (PDCCH), or a sidelink control channel, or a group-cast channel, or a broadcast channel. The information indicating to the apparatus the first portion of the time-frequency resources may be included in a downlink control information (DCI) or in a sidelink control information (SCI). The information indicating to the apparatus the first portion of the time-frequency resources may include at least one of first information indicative of one or more symbols corresponding to the first portion of the time-frequency resources or second information indicative of one or more frequency locations corresponding to the first portion of the time-frequency resources.

In some embodiments, the time-frequency resources may be configured by one or a combination of the information indicating to the apparatus the first portion of the time-frequency resources or another signaling. The information indicating to the apparatus the first portion of the time-frequency resources or the other signaling may be included in at least one of a higher-layer signaling, a dynamic signaling, or a preconfiguration by the network.

At step 1620, the apparatus punctures the first portion of the time-frequency resources in accordance with the information received from the device. Put another way, the apparatus will transmit nothing on the first portion of the time-frequency resources indicated in the information received from the device.

At step 1630, the apparatus performs, to the device, the transmission on a second portion of the time-frequency resources. The second portion of the time-frequency resources excludes the punctured first portion. As such, the apparatus transmits nothing on the punctured first portion of the time-frequency. The second portion of the time-frequency resources may include a RS that the apparatus transmits to the device. In some embodiments, the apparatus may previously receive, from the device, an indication to send the RS on a particular time-frequency location (e.g. on a particular symbol and RE(s) in the symbol) in the second portion of the time-frequency resources. In some embodiments, the time-frequency resources at which the RS is transmitted by the apparatus may include one or more symbols in a receiving direction of the apparatus that together overlap with the symbol at which the RS is transmitted by the apparatus. The one or more symbols in the receiving direction include a third portion that is at the same frequency location as the RS and is punctured. For example, FIG. 12 illustrates an example where the time-frequency resources at which RS 713a is transmitted by the apparatus includes two symbols in a receiving direction of the apparatus that together overlap with the symbol at which the RS 713a is transmitted by the apparatus. The third portion 1203p is at the same frequency location of RS 713a and is punctured by the device.

At step 1640, the apparatus may receive, from the device, another RS on a symbol that overlaps with or is covered by one or more symbols of the time-frequency resources in a transmitting direction of the apparatus and a receiving direction of the device. The overlapping one or more symbols of the time-frequency resources may include the punctured first portion. Therefore, put another way, the apparatus may receive, from the device, another RS on the punctured first portion, as scheduled. While FIG. 16 illustrates the apparatus receiving the other RS on the punctured first portion after the apparatus transmits the second portion of the time-frequency resources in step 1630, the apparatus may receive the other RS on the punctured first portion before the apparatus transmits the second portion of the time-frequency resources, or the first portion may be surrounded by the second portion. FIG. 12 illustrates an example in which RS 1203b is transmitted on punctured first portion 713p, and second portion 710 is the uplink transmission of UE 110x excluding punctured first portion 713p.

In some embodiments of the method of FIG. 16, a RS is sent from the device (like in step 1640), and the time-frequency resources include one or more symbols in a transmitting direction of the apparatus that together overlap with a symbol at which the RS from the device is sent. The one or more symbols in the transmitting direction of the apparatus include the first portion of the time-frequency resources. The RS may be transmitted at the same frequency location as the first portion of the time-frequency resources. For example, in FIG. 12, the RS 1203b is transmitted from the device, and two symbols in a transmitting direction of the apparatus overlap with the symbol at which the RS 1203b is sent. The two symbols include punctured first portion 713p. The RS 1203b is transmitted at the same frequency location as the punctured first portion 713p.

Independent of the specific method of FIG. 16 (e.g. without implementing any puncturing), or alternatively as part of the method of FIG. 16, the following operations may occur: the apparatus may receive, from the device, a dynamic signaling including an indication of timing advance adjustment to be applied to a transmission sent by the apparatus to the device. In some embodiments, the apparatus may receive, from the device in higher layer signaling, an indication of a first timing advance adjustment to be applied to a transmission sent by the apparatus to the device. In some embodiments the apparatus may receive, from the device in DCI, an indication of a second timing advance adjustment to be applied instead of or in addition to the first timing advance adjustment. The timing advance adjustment embodiments herein may be implemented independent of the puncturing embodiments herein, or they may be implemented in combination.

In some embodiments, there is provided an apparatus to perform any one of the apparatus methods described herein. The apparatus may include a memory to store processor-executable instructions, and a processor to execute the processor-executable instructions. The instructions, when executed, may cause the apparatus to perform the methods above (e.g. receiving information indicating to the apparatus the first portion of time-frequency resources, and sending the transmission on the second portion of the time-frequency resources).

In some embodiments, there is provided a device to perform any one of the device methods described herein. The device may include a memory to store processor-executable instructions, and a processor to execute the processor-executable instructions. The instructions, when executed, may cause the device to perform the methods above (e.g. transmitting, to an apparatus, information indicating to the apparatus the first portion of time-frequency resources, and receiving the transmission of the apparatus on the second portion of the time-frequency resources).

The method in FIG. 17 illustrates a method for protecting a reference signal and possibly adjusting timing advance (TA) in support of transmission between the device and the apparatus in a network.

At step 1710, the device transmits, to the apparatus, an indication to send a RS in a transmission of the apparatus on a symbol included in time-frequency resources. In some embodiments, the device may also transmit, to the apparatus, a dynamic signaling including an indication of timing advance adjustment to be applied to a transmission sent by the apparatus to the device. The dynamic signaling may be transmitted separately from or together with the indication to send the RS in the transmission of the apparatus. In some other embodiments, the device may transmit, to the apparatus in higher layer signaling, an indication of a first timing advance adjustment to be applied to a transmission sent by the apparatus to the device. Instead of or in addition to the first timing advance adjustment, the device may transmit, to the apparatus in DCI, an indication of a second timing advance adjustment to be applied. The indication of the first and/or second timing advance adjustments may be transmitted separately from or together with the indication to send the RS in the transmission of the apparatus.

At step 1720, the device punctures, in a transmitting direction, a portion of the time-frequency resources (e.g. third portion or punctured portion 1203p in the present disclosure). This punctured portion of the time-frequency resources is included, in a transmitting direction of the device, in one or more symbols at a frequency location at which the RS is to be received by the device. The one or more symbols in which the puncture portion is included together overlap with the symbol at which the RS is to be received by the device.

At step 1730, the device receives, from the apparatus, the RS on the symbol which overlaps with or is covered by the one or more symbols mentioned at step 1720. Again, the one or more symbols include the time-frequency resource portion that is punctured, at step 1720, by the device in the transmitting direction.

One example of the result of FIG. 17 is that illustrated in FIG. 12 in which the RS 713a is received by the device (e.g. TRP 352), from the apparatus (e.g. UE 110x). The RS 713a is received on a symbol that overlaps with punctured portion 1203p.

In some embodiments, there may be provided a UE that is capable of FD operation and supporting simultaneous transmission and reception as defined or RRC configured by one or more parameters, e.g., simultaneousRxTxInterBandENDC, simultaneousRxTxInterBandCA and/or simultaneousRxTxSUL in NR among all cells within a group of cells. Such UE may be expected to transmit and/or receive traffic in a slot within a configured FD frame.

If the UE indicates its capability and support of FD operation, a new DCI format may be configured and/or received. The UE transmission(s) may be dynamically scheduled by the new DCI format (e.g. DCI format x), in which an indication field is provided to indicate if the scheduled time-frequency resources are intended for DL transmission, UL transmission, or both DL and UL transmissions. To support FD operation in either one node or both nodes, the new DCI format (e.g., DCI format x) or new/modified fields in an existing DCI format may be defined and used to carry out the schedule of DL and/or UL transmissions and timing alignment (e.g. TA adjustment) command for one or more cells. The following information may be included in the new/modified field(s) of an associated DCI format for FD operation, and/or transmitted by means of the new DCI format (e.g. DCI format x) with CRC scrambled by FD-RNTI:
identifier for DCI formats (2 bits)—e.g., “00” for DL transmission only, “01” for UL transmission only, “10” for both DL and UL transmissions, “11” reserved for other use; and/or
identifier for timing alignment (e.g. TA adjustment) command (X bits)—e.g., use X (>=1) bits to indicate TA adjustment.

If a UE indicates its capability and support of FD operation, the UE may be configured with multiple serving cells and for a set of symbols in a slot that are associated with the UE for reception of SS/PBCH (synchronization signal/physical broadcast channel) blocks in the first cell of the multiple serving cells. Moreover, the UE may transmit via PUSCH, PUCCH (physical uplink control channel), or PRACH (physical random access channel) in the slot associated with the UE, if the transmission would overlap with any symbol of the set of symbols in the slot associated with the UE. The UE may transmit SRS (sounding reference signal) in the set of symbols in the slot associated with the UE.

In some other embodiments, a timing alignment command (e.g. timing advance command, T_{A}) for a TAG (timing advance group) indicates adjustment of a current N_{TA} value, N_{TA_old}, to the new N_{TA} value, N_{TA_new}, using index values of T_{A}=0, 1, 2, . . . , 63, where N_{TA_new}=N_{TA_old}+(T_{A}−31)·16·64/2^{μ} for a SCS of 24.15 kHz.

If the UE indicates its capability and support of FD operation, a new DCI format (e.g, DCI format x) may be used to carry out a timing alignment command (e.g. T_{A}) for the TAG.

If the UE indicates its capability and support of FD operation, for a timing alignment command (e.g. timing advance command) received on slot n and for a transmission other than a PUSCH transmission scheduled by a RAR (random access response) UL grant or a fallbackRAR UL grant, or a PUCCH transmission with hybrid automatic repeat request acknowledgement (HARQ-ACK) information in response to a successRAR, the corresponding timing alignment (e.g. TA adjustment) value for the UL transmission may be applied from the beginning of UL slot n+k+1, where k is associated with maximum of a time duration corresponding to a reception processing time and a time duration corresponding to a transmission preparation time for a UE processing capability.

The following technical benefit may be achieved in some embodiments: the device (e.g. base station) can be operated in full-duplex (FD) transmission mode while the apparatus (e.g. UE) is operated in half-duplex (HD) transmission mode.

The following technical benefit may be achieved in some other embodiments: both the device and the apparatus can be operated in full-duplex (FD) transmission mode at the same time.

The following technical benefit may be achieved in some embodiments: network operation is enhanced in that spectrum usage efficiency is improved (e.g. significant increase on spectrum usage) due to FD operation, while signaling overhead, power consumption and transmission latency may possibly be decreased.

The following technical benefit may be achieved in some embodiments: timing alignment can be configured dynamically.

The following technical benefit may be achieved in some embodiments: the apparatuses, devices and methods proposed in the present disclosure can be widely used in various wireless network environments.

The following technical benefit may be achieved in some embodiments: timing alignments and resource puncturing in FD transmissions and receptions for both the device and the apparatus.

The embodiments described above are primarily in the context of UEs communicating with a TRP. However, more generally, devices that wirelessly communicate with each other over time-frequency resources need not necessarily be one or more UEs communicating with a TRP. For example, two or more UEs may wirelessly communicate with each other over a sidelink using device-to-device (D2D) communication. As another example, two network devices (e.g. a terrestrial base station and a non-terrestrial base station, such as a drone) may wirelessly communicate with each other over a backhaul link. Embodiments are not limited to uplink and/or downlink communication. For example, in the embodiments above, the TRP 352 may be substituted with another device, such as a node in the network or a UE. The uplink/downlink communication may instead be sidelink communication or other D2D communication.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

What is claimed is:

1. A method, applied in an apparatus, the method comprising:
receiving information indicating to the apparatus a first portion of time-frequency resources, wherein the first portion of the time-frequency resources is to be punctured for a transmission of the apparatus; and
sending the transmission on a second portion of the time-frequency resources, the second portion of the time-frequency resources excluding the first portion of the time-frequency resources.

2. The method of claim 1, further comprising:
receiving an indication to send a reference signal (RS) in the transmission on a symbol included in the time-frequency resources; and
sending the RS on the symbol.

3. The method of claim 2, wherein the time-frequency resources include one or more symbols in a receiving direction that together overlap with the symbol at which the RS is transmitted by the apparatus.

4. The method of claim 3, wherein the one or more symbols in the receiving direction include a third portion of the time-frequency resources that is at the same frequency location as the RS and is punctured.

5. The method of claim 1, wherein the information indicating to the apparatus the first portion of the time-frequency resources is received on a control channel, wherein the control channel is a physical downlink control channel (PDCCH), or a sidelink control channel, or a group-cast channel, or a broadcast channel.

6. The method of claim 1, further comprising:
receiving a dynamic signaling including an indication of timing advance adjustment to be applied to the transmission sent by the apparatus.

7. The method of claim 1, further comprising:
receiving, in higher layer signaling, an indication of a first timing advance adjustment to be applied to the transmission sent by the apparatus; and
receiving, in downlink control information (DCI), an indication of a second timing advance adjustment to be applied instead of, or in addition to, the first timing advance adjustment.

8. An apparatus comprising:
a memory storing processor-executable instructions; and
at least one processor configured to execute the processor-executable instructions, causing the apparatus to:
receive information indicating to the apparatus a first portion of time-frequency resources, wherein the first portion of the time-frequency resources is to be punctured for a transmission of the apparatus; and
send the transmission on a second portion of the time-frequency resources, the second portion of the time-frequency resources excluding the first portion of the time-frequency resources.

9. The apparatus of claim 8, wherein the instructions, when executed by the at least one processor, further cause the apparatus to:
receive an indication to send a reference signal (RS) in the transmission on a symbol included in the time-frequency resources; and
send the RS on the symbol.

10. The apparatus of claim 8, wherein the time-frequency resources include one or more symbols in a receiving direction that together overlap with the symbol at which the RS is transmitted by the apparatus.

11. A method, applied in a device operating in full-duplex (FD) mode, the method comprising:
transmitting information indicating to an apparatus a first portion of time-frequency resources, wherein the first portion of the time-frequency resources is to be punctured by the apparatus for a transmission of the apparatus; and
receiving the transmission of the apparatus on a second portion of the time-frequency resources, the second portion of the time-frequency resources excluding the first portion of the time-frequency resources.

12. The method of claim 11, further comprising transmitting a reference signal (RS) on the first portion of the time-frequency resources.

13. The method of claim 11, further comprising:
transmitting an indication to transmit a RS on a symbol included in the time-frequency resources;
puncturing, in a transmitting direction, a time-frequency location at which the RS is to be received; and
receiving the RS on the symbol.

14. The method of claim 13, wherein the time-frequency resources include one or more symbols in the transmitting direction that together overlap with the symbol at which the RS is transmitted by the apparatus.

15. The method of claim 14, wherein the one or more symbols in the transmitting direction include a third portion of the time-frequency resources that is at the same frequency location as the RS and is punctured by the device.

16. The method of claim 11, wherein the information indicating to the apparatus the first portion of the time-frequency resources is transmitted in a control channel, wherein the control channel is a physical downlink control channel (PDCCH), or a sidelink control channel, or a group-cast channel, or a broadcast channel.

17. The method of claim 16, wherein the information indicating to the apparatus the first portion of the time-frequency resources includes at least one of:
first information indicative of one or more symbols corresponding to the first portion of the time-frequency resources; or
second information indicative of one or more frequency locations corresponding to the first portion of the time-frequency resources.

18. The method of claim 11, further comprising:
transmitting a dynamic signaling including an indication of a timing advance adjustment to be applied to the transmission sent by the apparatus.

19. A device operating in full-duplex (FD) mode, the device comprising:
a memory storing processor-executable instructions; and
at least one processor to execute the processor-executable instructions to cause the device to:
transmit information indicating to an apparatus a first portion of time-frequency resources, wherein the first portion of the time-frequency resources is to be punctured by the apparatus for a transmission of the apparatus; and
receive the transmission of the apparatus on a second portion of the time-frequency resources, the second portion of the time-frequency resources excluding the first portion of the time-frequency resources.

20. The device of claim 19, wherein the instructions when executed by the at least one processor further cause the device to transmit a reference signal (RS) on the first portion of the time-frequency resources.
